(19) United States
(12) Patent Application Publication
(10) Pub. No.: US 2022/0371906 A1
(43) Pub. Date: Nov. 24, 2022

(54) POSITIVE ELECTRODE ACTIVE MATERIAL, POSITIVE ELECTRODE, SECONDARY BATTERY, AND MANUFACTURING METHOD THEREOF

(71) Applicant: SEMICONDUCTOR ENERGY LABORATORY CO., LTD., ATSUGI-SHI, KANAGAWA-KEN (JP)

(72) Inventors: Kazuhei NARITA, Ota, Tokyo (JP); Jo SAITO, Atsugi, Kanagawa (JP); Yohei MOMMA, Isehara, Kanagawa (JP); Teruaki OCHIAI, Atsugi, Kanagawa (JP); Mayumi MIKAMI, Atsugi, Kanagawa (JP)

(21) Appl. No.: 17/621,792

(22) PCT Filed: Jun. 16, 2020
(86) PCT No.: PCT/IB2020/055594

§ 371 Date: Dec. 22, 2021

(30) Foreign Application Priority Data
Jun. 28, 2019 (JP) 2019-121182

(51) Int. Cl. C01D 15/02; H01M 10/0525; H01M 4/40; C01G 51/00; C01G 53/00; C01F 7/162; C01F 7/78

(52) U.S. Cl. CPC C01D 15/02; H01M 10/0525; H01M 4/405; C01G 51/006; C01G 51/66; C01G 53/006; C01G 53/66; C01F 7/162; C01F 7/78; H01M 2004/027

(57) ABSTRACT

A positive electrode active material that has high capacity and excellent charge and discharge cycle performance for a secondary battery is provided. The positive electrode active material includes a group of particles including a first group of particles and a second group of particles. The group of particles includes lithium, cobalt, nickel, aluminum, magnesium, oxygen, and fluorine. When the number of cobalt atoms included in the group of particles is taken as 100, the number of nickel atoms is greater than or equal to 0.05 and less than or equal to 2, the number of aluminum atoms is greater than or equal to 0.05 and less than or equal to 2, and the number of magnesium atoms is greater than or equal to 0.1 and less than or equal to 6. When particle size distribution in the group of particles is measured by a laser diffraction and scattering method, the first group of particles has a first peak and the second group of particles has a second peak; the first peak has a local maximum value at longer than or equal to 2 μm and shorter than or equal to 4 μm, and the second peak has a local maximum value at longer than or equal to 9 μm and shorter than or equal to 25 μm.

### TECHNICAL FIELD

One embodiment of the present invention relates to an object, a method, or a manufacturing method. Alternatively, the present invention relates to a process, a machine, manufacture, or a composition (composition of matter). One embodiment of the present invention relates to a semiconductor device, a display device, a light-emitting device, a power storage device, a lighting device, an electronic device, or a manufacturing method thereof. In particular, one embodiment of the present invention relates to a positive electrode active material that can be used for a secondary battery, a secondary battery, and an electronic device including a secondary battery.

Note that in this specification, a power storage device refers to every element and device having a function of storing power. Examples of the power storage device include a storage battery (also referred to as a secondary battery) such as a lithium-ion secondary battery, a lithium-ion capacitor, and an electric double layer capacitor.

In addition, electronic devices in this specification mean all devices including power storage devices, and electro-optical devices including power storage devices, information terminal devices including power storage devices, and the like are all electronic devices.

### BACKGROUND ART

In recent years, a variety of power storage devices such as lithium-ion secondary batteries, lithium-ion capacitors, and air batteries have been actively developed. In particular, demand for lithium-ion secondary batteries with high output and high capacity has rapidly grown with the development of the semiconductor industry, and the lithium-ion secondary batteries are essential as rechargeable energy supply sources for the current information society.

The performance required for lithium-ion secondary batteries includes much higher energy density, improved cycle performance, safety under a variety of operation environments, and improved long-term reliability.

It is effective to increase the carried amount of a positive electrode active material in a positive electrode to increase the energy density; Patent Document 1 and Patent Document 2, for example, attempt to achieve this.

In addition, the crystal structure of a positive electrode active material has been studied in Non-Patent Document 1 to Non-Patent Document 3.

Non-Patent Document 3 illustrates an example in which the interatomic distance of LiNi₁₋ₓMₓO₂ is calculated utilizing the first principles calculation. Furthermore, Non-Patent Document 4 describes generation energy of a silicon oxide compound, which is obtained by the first principles calculation.

X-ray diffraction (XRD) is one of methods used for analysis of a crystal structure of a positive electrode active material. With the use of the ICSD (Inorganic Crystal Structure Database) described in Non-Patent Document 5, XRD data can be analyzed.

Moreover, as disclosed in Non-Patent Document 6 and Non-Patent Document 7, energy depending on the crystal structure, composition, or the like of a compound can be calculated with the use of the first principles calculation.

### REFERENCES

### Patent Documents

[Patent Document 1] Japanese Published Patent Application No. 2019-021456
[Patent Document 2] Japanese Published Patent Application No. 2008-153197

### Non-Patent Documents

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 2012, 22, pp. 17340-17348.
[Non-Patent Document 2] Motohashi, T. et al., “Electronic phase diagram of the layered cobalt oxide system LiₓCoO₂ (0.0≤x≤1.0)”, Physical Review B, 80 (16), 2009, 165114.
[Non-Patent Document 3] Zhaohui Chen et al., “Staging Phase Transitions in LixCoO₂, Journal of The Electrochemical Society, 2002, 149 (12) A1604-A1609.
[Non-Patent Document 4] W. E. Counts et al., Journal of the American Ceramic Society, 1953, 36 [1] 12-17. Fig. 01471.
[Non-Patent Document 5] Belsky, A. et al., “New developments in the Inorganic Crystal Structure Database (ICSD): accessibility in support of materials research and design”, Acta Cryst., 2002, B58, 364-369.
[Non-Patent Document 6] Dudarev, S. L. et al., “Electron-energy-loss spectra and the structural stability of nickel oxide: An LSDA1U study”, Physical Review B, 1998, 57 (3) 1505.
[Non-Patent Document 7] Zhou, F. et al., “First-principles prediction of redox potentials in transition-metal compounds with LDA+U”, Physical Review B, 2004, 70 235121.

### SUMMARY OF THE INVENTION

### Problems to be Solved by the Invention

An object of one embodiment of the present invention is to provide a positive electrode active material that has high capacity and excellent charge and discharge cycle performance for a secondary battery. Another object is to provide a positive electrode active material with high powder packing density. Another object is to provide a positive electrode active material with a small particle diameter. Another object is to provide a positive electrode that has high capacity and excellent charge and discharge cycle performance for a secondary battery. Another object is to provide a method for forming a positive electrode active material with high productivity. Another object of one embodiment of the present invention is to provide a positive electrode active material that inhibits a decrease in capacity in charge and discharge cycles when used for a secondary battery. Another object of one embodiment of the present invention is to provide a high-capacity secondary battery. Another object of one embodiment of the present invention is to provide a secondary battery with excellent charge and discharge performance. Another object of one embodiment of the present invention is to provide a highly safe or reliable secondary battery.

Another object of one embodiment of the present invention is to provide a novel material, novel active material particles, a novel power storage device, or a manufacturing method thereof.

Note that the description of these objects does not preclude the existence of other objects. One embodiment of the present invention does not have to achieve all these objects. Other objects can be derived from the description of the specification, the drawings, and the claims.

### Means for Solving the Problems

To achieve the above objects, a positive electrode active material with a small particle diameter that has excellent charge and discharge cycle performance is manufactured in one embodiment of the present invention. Mixing this positive electrode active material with a positive electrode active material with a large particle diameter that has excellent charge and discharge cycle performance can improve the capacity per volume of the secondary battery.

One embodiment of the present invention is a positive electrode active material including a group of particles. The group of particles includes a first group of particles and a second group of particles. The group of particles includes lithium, cobalt, nickel, aluminum, magnesium, oxygen, and fluorine. When the number of cobalt atoms included in the group of particles is taken as 100, the number of nickel atoms is greater than or equal to 0.05 and less than or equal to 2, the number of aluminum atoms is greater than or equal to 0.05 and less than or equal to 2, and the number of magnesium atoms is greater than or equal to 0.1 and less than or equal to 6. When particle size distribution in the group of particles is measured by a laser diffraction and scattering method, the first group of particles has a first peak and the second group of particles has a second peak; the first peak has a local maximum value at longer than or equal to 2 μm and shorter than or equal to 4 μm, and the second peak has a local maximum value at longer than or equal to 9 μm and shorter than or equal to 25 μm.

In the above embodiment, the powder packing density of the positive electrode active material is preferably greater than or equal to 4.30 g/cc and less than or equal to 4.60 g/cc.

In the above embodiment, when a lithium-ion secondary battery in which the group of particles is used in a positive electrode and metallic lithium is used in a negative electrode is charged at a constant current under a 25° C. environment until a battery voltage reaches 4.6 V and then charged at a constant voltage until a current value reaches 0.02 C and after that the positive electrode is analyzed by powder X-ray diffraction with a CuKα1 ray, diffraction peaks preferably appear at 2θ=19.30±0.20° and 2θ=45.55±0.10°.

Another embodiment of the present invention is a positive electrode active material including a group of particles including lithium, cobalt, nickel, aluminum, magnesium, oxygen, and fluorine. When the number of cobalt atoms included in the group of particles is taken as 100, the number of nickel atoms is greater than or equal to 0.05 and less than or equal to 2, the number of aluminum atoms is greater than or equal to 0.05 and less than or equal to 2, and the number of magnesium atoms is greater than or equal to 0.1 and less than or equal to 6. When particle size distribution is measured by a laser diffraction and scattering method, a local maximum value appears at longer than or equal to 2 μm and shorter than or equal to 4 μm. When a lithium-ion secondary battery in which the group of particles is used in a positive electrode and metallic lithium is used in a negative electrode is charged at a constant current under a 25° C. environment until a battery voltage reaches 4.6 V and then charged at a constant voltage until a current value reaches 0.02 C and after that the positive electrode is analyzed by powder X-ray diffraction with a CuKα1 ray, diffraction peaks appear at 2θ=19.30±0.20° and 2θ=45.55±0.10°.

Another embodiment of the present invention is a manufacturing method of a positive electrode active material including a first step of forming a first group of particles including lithium, cobalt, nickel, aluminum, magnesium, oxygen, and fluorine and having D₅₀ of longer than or equal to 2 μm and shorter than or equal to 4 μm when particle size distribution is measured by a laser diffraction and scattering method; a second step of forming a second group of particles including lithium, cobalt, nickel, aluminum, magnesium, oxygen, and fluorine and having D₅₀ of longer than or equal to 16 μm and shorter than or equal to 22 μm when particle size distribution is measured by a laser diffraction and scattering method; and a third step of forming a group of particles by mixing the first group of particles and the second group of particles. The proportion of the first group of particles in the group of particles is greater than or equal to 5 weight % and less than or equal to 20 weight %.

In the above embodiment, the first step preferably includes a step of crushing with a thin-film spin system mixer.

### Effect of the Invention

According to one embodiment of the present invention, a positive electrode active material that has high capacity and excellent charge and discharge cycle performance for a secondary battery can be provided. A positive electrode active material with high powder packing density can be provided. A positive electrode active material with a small particle diameter can be provided. A positive electrode that has high capacity and excellent charge and discharge cycle performance for a secondary battery can be provided. A method for forming a positive electrode active material with high productivity can be provided. According to one embodiment of the present invention, a positive electrode active material that inhibits a decrease in capacity in charge and discharge cycles when used for a secondary battery can be provided. According to one embodiment of the present invention, a high-capacity secondary battery can be provided. According to one embodiment of the present invention, a secondary battery with excellent charge and discharge performance can be provided. According to one embodiment of the present invention, a highly safe or reliable secondary battery can be provided.

### BRIEF DESCRIPTION OF THE DRAWINGS

FIG. 1 is a diagram illustrating the charge depth and crystal structures of a positive electrode active material.

FIG. 2 is a diagram illustrating the charge depth and crystal structures of a positive electrode active material.

FIG. 3 is an XRD pattern calculated from crystal structures.

FIG. 4 is a diagram illustrating an example of a method for manufacturing a positive electrode active material.

FIG. 5 is a diagram illustrating an example of a method for manufacturing a positive electrode active material.

FIG. 6A and FIG. 6B are diagrams each illustrating an example of a secondary battery.

FIG. 7 is a diagram illustrating an example of a secondary battery.

FIG. 8A and FIG. 8B are diagrams illustrating a coin-type secondary battery. FIG. 8C is a diagram illustrating a current flow of a secondary battery.

FIG. 9A and FIG. 9B are diagrams illustrating a cylinder-type secondary battery. FIG. 9C and

FIG. 9D are diagrams illustrating a module including a plurality of cylinder-type secondary batteries.

FIG. 10A and FIG. 10B are diagrams illustrating an example of a secondary battery.

FIG. 11A to FIG. 11D are diagrams illustrating an example of a secondary battery.

FIG. 12A and FIG. 12B are diagrams illustrating an example of a secondary battery.

FIG. 13 is a diagram illustrating an example of a secondary battery.

FIG. 14A to FIG. 14C are diagrams illustrating a laminated secondary battery.

FIG. 15A and FIG. 15B are diagrams illustrating a laminated secondary battery.

FIG. 16 is a diagram showing an external view of a secondary battery.

FIG. 17 is a diagram showing an external view of a secondary battery.

FIG. 18A to FIG. 18C are diagrams illustrating a method for manufacturing a secondary battery.

FIG. 19A and FIG. 19B are diagrams illustrating an example of a secondary battery and a manufacturing method thereof.

FIG. 20A to FIG. 20C are diagrams illustrating an example of a secondary battery.

FIG. 21A and FIG. 21B are diagrams illustrating an example of a secondary battery.

FIG. 22A to FIG. 22H are diagrams illustrating examples of electronic devices.

FIG. 23A to FIG. 23C are diagrams illustrating an example of an electronic device.

FIG. 24 is a diagram illustrating examples of electronic devices.

FIG. 25A to FIG. 25C are diagrams illustrating examples of vehicles.

FIG. 26 is a graph showing the particle size distributions of positive electrode active materials.

FIG. 27 is a graph showing the powder packing density of a positive electrode active material.

FIG. 28A and FIG. 28B are cross-sectional SEM images of a positive electrode.

FIG. 29 is XRD patterns of positive electrodes.

FIG. 30A and FIG. 30B are XRD patterns of positive electrodes.

FIG. 31A and FIG. 31B are graphs showing the cycle performance of secondary batteries.

FIG. 32A and FIG. 32B are graphs showing the cycle performance of secondary batteries.

FIG. 33A and FIG. 33B are graphs showing the cycle performance of secondary batteries.

FIG. 34A and FIG. 34B are graphs showing the cycle performance of secondary batteries.

### MODE FOR CARRYING OUT THE INVENTION

Hereinafter, embodiments are described with reference to the drawings. Note that the embodiments can be implemented with many different modes, and it is readily understood by those skilled in the art that modes and details thereof can be changed in various ways without departing from the spirit and scope thereof. Thus, the present invention should not be construed as being limited to the following description of the embodiments.

Note that ordinal numbers such as “first”, “second”, and “third” in this specification and the like are used in order to avoid confusion among components. Thus, the ordinal numbers do not limit the number of components. In addition, the ordinal numbers do not limit the order of components. Furthermore, in this specification and the like, for example, a “first” component in one embodiment can be referred to as a “second” component in other embodiments or claims. Moreover, in this specification and the like, for example, a “first” component in one embodiment can be omitted in other embodiments or claims.

Note that in the drawings, the same elements, elements having similar functions, elements formed of the same material, elements formed at the same time, or the like are sometimes denoted by the same reference numerals, and repeated description thereof is omitted in some cases.

In this specification and the like, crystal planes and orientations are indicated by the Miller index. In the crystallography, a bar is placed over a number in the expression of crystal planes and orientations; however, in this specification and the like, because of application format limitations, crystal planes and orientations may be expressed by placing a minus sign (−) at the front of a number instead of placing a bar over the number. Furthermore, an individual direction that shows an orientation in a crystal is denoted by “[ ]”, a set direction that shows all of the equivalent orientations is denoted by “< >”, an individual plane that shows a crystal plane is denoted by “( )”, and a set plane having equivalent symmetry is denoted by “{ }”.

In this specification and the like, a superficial portion of a particle of an active material or the like refers to a region from a surface to a depth of approximately 10 nm. A plane generated by a split or a crack may also be referred to as a surface. In addition, a region whose position is deeper than that of the superficial portion is referred to as an inner portion.

In this specification and the like, a layered rock-salt crystal structure of a composite oxide containing lithium and a transition metal refers to a crystal structure in which a rock-salt ion arrangement where cations and anions are alternately arranged is included and the transition metal and lithium are regularly arranged to form a two-dimensional plane, so that lithium can be two-dimensionally diffused. Note that a defect such as a cation or anion vacancy may exist. Moreover, in the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist.

In this specification and the like, a pseudo-spinel crystal structure of a composite oxide containing lithium and a transition metal refers to a crystal structure with a space group R-3m, which is not a spinel crystal structure but a crystal structure where oxygen is hexacoordinated to ions of cobalt, magnesium, or the like and the cation arrangement has symmetry similar to that of the spinel crystal structure. Note that in the pseudo-spinel crystal structure, oxygen is tetracoordinated to a light element such as lithium in some cases. Also in that case, the ion arrangement has symmetry similar to that of the spinel crystal structure.

The pseudo-spinel crystal structure can also be regarded as a crystal structure that contains Li between layers at random but is similar to a CdCl₂ type crystal structure. The crystal structure similar to the CdCl₂ type crystal structure is close to a crystal structure of lithium nickel oxide when charged up to a charge depth of 0.94 (Li_{0.06}NiO₂); however, pure lithium cobalt oxide or a layered rock-salt positive electrode active material containing a large amount of cobalt is known not to have this crystal structure in general.

Anions of a layered rock-salt crystal and anions of a rock-salt crystal have a cubic close-packed structure (face-centered cubic lattice structure). Anions of a pseudo-spinel crystal are also presumed to have a cubic close-packed structure. When the pseudo-spinel crystal is in contact with the layered rock-salt crystal and the rock-salt crystal, there is a crystal plane at which orientations of cubic close-packed structures composed of anions are aligned. Note that a space group of the layered rock-salt crystal and the pseudo-spinel crystal is R-3m, which is different from a space group Fm-3m of a rock-salt crystal (a space group of a general rock-salt crystal) and a space group Fd-3m of a rock-salt crystal (a space group of a rock-salt crystal having the simplest symmetry); thus, the Miller index of the crystal plane satisfying the above conditions in the layered rock-salt crystal and the pseudo-spinel crystal is different from that in the rock-salt crystal. In this specification, a state where the orientations of the cubic close-packed structures composed of anions in the layered rock-salt crystal, the pseudo-spinel crystal, and the rock-salt crystal are aligned is sometimes referred to as a state where crystal orientations are substantially aligned.

Whether the crystal orientations in two regions are substantially aligned can be judged from a TEM (transmission electron microscope) image, a STEM (scanning transmission electron microscope) image, a HAADF-STEM (high-angle annular dark field scanning transmission electron microscope) image, an ABF-STEM (annular bright-field scanning transmission electron microscope) image, and the like. X-ray diffraction (XRD), electron diffraction, neutron diffraction, and the like can also be used for judging. In a TEM image and the like, alignment of cations and anions can be observed as repetition of bright lines and dark lines. When the orientations of cubic close-packed structures in the layered rock-salt crystal and the rock-salt crystal are aligned, a state where an angle made by the repetition of bright lines and dark lines in the crystals is less than or equal to 5°, preferably less than or equal to 2.5° can be observed. Note that in a TEM image and the like, contrast between background and a light element typified by oxygen or fluorine cannot adequately be obtained in some cases; in such a case, alignment of orientations can be judged by arrangement of metal elements.

In this specification and the like, theoretical capacity of a positive electrode active material refers to the amount of electricity at the time when lithium that can be inserted and extracted and is contained in the positive electrode active material is all extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification and the like, charge depth at the time when lithium that can be inserted and extracted is all inserted is 0, and charge depth at the time when lithium that can be inserted and extracted and is contained in a positive electrode active material is all extracted is 1.

In this specification and the like, charging refers to transfer of lithium ions from a positive electrode to a negative electrode in a battery and transfer of electrons from a positive electrode to a negative electrode in an external circuit. For a positive electrode active material, extraction of lithium ions is called charging. Moreover, a positive electrode active material with a charge depth of greater than or equal to 0.74 and less than or equal to 0.9, more specifically, a charge depth of greater than or equal to 0.8 and less than or equal to 0.83 is referred to as a high-voltage charged positive electrode active material. Thus, for example, LiCoO₂ charged to 219.2 mAh/g is a high-voltage charged positive electrode active material. In addition, LiCoO₂ that is subjected to constant current charging in an environment at 25° C. and charging voltage of higher than or equal to 4.525 V and lower than or equal to 4.65 V (in the case of a lithium counter electrode), and then subjected to constant voltage charging until the current value becomes 0.02 C or approximately ⅕ to 1/100 of the current value at the time of the constant current charging is also referred to as a high-voltage charged positive electrode active material.

Similarly, discharging refers to transfer of lithium ions from a negative electrode to a positive electrode in a battery and transfer of electrons from a negative electrode to a positive electrode in an external circuit. For a positive electrode active material, insertion of lithium ions is called discharging. A positive electrode active material with a charge depth of less than or equal to 0.06 or a positive electrode active material from which more than or equal to 90% of the charge capacity is discharged from a state where the positive electrode active material is charged with high voltage is referred to as a sufficiently discharged positive electrode active material. For example, LiCoO₂ with a charge capacity of 219.2 mAh/g is in a state of being charged with high voltage, and a positive electrode active material from which more than or equal to 197.3 mAh/g, which is 90% of the charge capacity, is discharged is a sufficiently discharged positive electrode active material. In addition, LiCoO₂ that is subjected to constant current discharging in an environment at 25° C. until the battery voltage becomes lower than or equal to 3 V (in the case of a lithium counter electrode) is also referred to as a sufficiently discharged positive electrode active material.

In this specification and the like, an unbalanced phase change refers to a phenomenon that causes a nonlinear change in physical quantity. For example, an unbalanced phase change is presumed to occur around a peak in a dQ/dV curve obtained by differentiating capacitance (Q) with voltage (V) (dQ/dV), resulting in a large change in the crystal structure.

### Embodiment 1

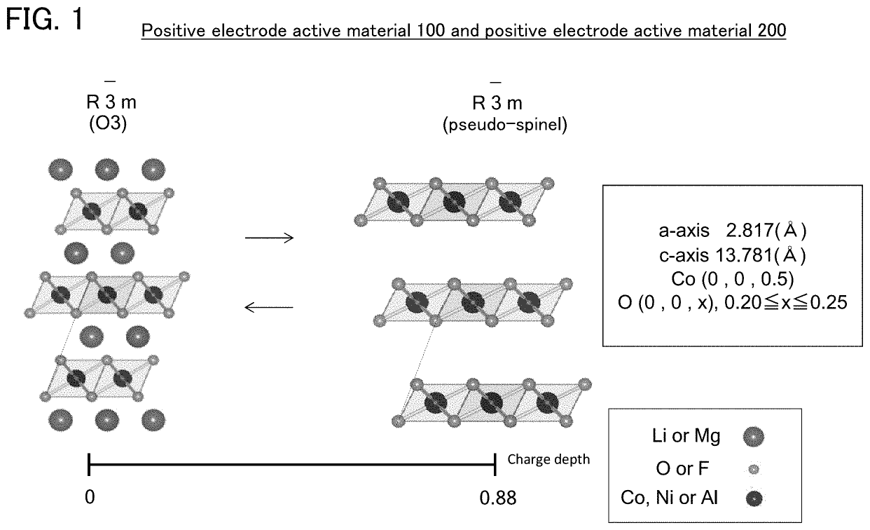

In this embodiment, a positive electrode active material of one embodiment of the present invention, a positive electrode including the positive electrode active material, and a method for forming the positive electrode active material will be described with reference to FIG. 1 to FIG. 5.

### [Positive Electrode Active Material 100]

A positive electrode active material 100 of one embodiment of the present invention is a group of particles of composite oxides containing lithium, cobalt, nickel, aluminum, magnesium, oxygen, and fluorine.

When particle size distribution in the positive electrode active material 100 is measured by a laser diffraction and scattering method, the local maximum value preferably exists at longer than or equal to 1 μm and shorter than or equal to 10 μm, further preferably longer than or equal to 1 μm and shorter than or equal to 6 μm, and still further preferably longer than or equal to 2 μm and shorter than or equal to 4 μm. Furthermore, D₅₀ preferably exists at longer than or equal to 1 μm and shorter than or equal to 10 μm, further preferably longer than or equal to 1 μm and shorter than or equal to 6 μm, and still further preferably longer than or equal to 2 μm and shorter than or equal to 4 μm.

When the positive electrode active material 100 with such a small particle diameter is used for a secondary battery, the contact area between the positive electrode active material and an electrolyte is increased and the moving distance of lithium ions and electrons in the particle can be shortened; thus, the internal resistance of the secondary battery can be reduced. This advantage can be obtained not only in the case of using a liquid electrolyte but also in the case of an all-solid-state secondary battery.

When the number of cobalt atoms included in the positive electrode active material 100 is taken as 100, the relative value of the number of nickel atoms is preferably greater than or equal to 0.05 and less than or equal to 2, further preferably greater than or equal to 0.1 and less than or equal to 1.5, and still further preferably greater than or equal to 0.1 and less than or equal to 0.9, for example.

When the number of cobalt atoms included in the positive electrode active material 100 is taken as 100, the relative value of the number of aluminum atoms is preferably greater than or equal to 0.05 and less than or equal to 2, further preferably greater than or equal to 0.1 and less than or equal to 1.5, and still further preferably greater than or equal to 0.1 and less than or equal to 0.9, for example.

When the number of cobalt atoms included in the positive electrode active material 100 is taken as 100, the relative value of the number of magnesium atoms is preferably greater than or equal to 0.1 and less than or equal to 6, and further preferably greater than or equal to 0.3 and less than or equal to 3, for example.

When nickel, aluminum, and magnesium are contained at the above concentrations, a stable crystal structure can be maintained even if the particle diameter is small and charge and discharge are repeated at high voltage. Thus, the positive electrode active material 100 can have high capacity and excellent charge and discharge performance. The atomic ratio between cobalt, nickel, aluminum, and magnesium can be measured by inductively coupled plasma mass spectrometry (ICP-MS), for example.

When the number of magnesium atoms included in the positive electrode active material 100 is taken as 1, the relative value of the number of fluorine atoms is preferably greater than or equal to 2 and less than or equal to 3.9, for example. Within this range of the value, the melting point can be effectively lowered without excessive lithium when a magnesium source and a fluorine source are mixed in a formation process as described later. The proportion of fluorine atoms can be measured by glow discharge mass spectrometry (GD-MS), for example.

### [Positive Electrode Active Material 200]

A group of particles in which the positive electrode active material 100 with a relatively small particle diameter and a positive electrode active material 200 with a larger particle diameter are mixed is preferably used for a secondary battery, in which case the capacity per volume can be improved.

When particle size distribution in the positive electrode active material 200 with a larger particle diameter is measured by, for example, a laser diffraction and scattering method, the local maximum value preferably exists at longer than or equal to 9 μm and shorter than or equal to 25 μm.

The positive electrode active material 200 is preferably a group of particles of composite oxides containing lithium, cobalt, nickel, aluminum, magnesium, oxygen, and fluorine like the positive electrode active material 100, in which case high capacity and excellent charge and discharge cycle performance can be obtained.

When the number of cobalt atoms included in the positive electrode active material 200 is taken as 100, the relative value of the number of nickel atoms is preferably greater than or equal to 0.05 and less than or equal to 2, further preferably greater than or equal to 0.1 and less than or equal to 1.5, and still further preferably greater than or equal to 0.1 and less than or equal to 0.9, for example.

When the number of cobalt atoms included in the positive electrode active material 200 is taken as 100, the relative value of the number of aluminum atoms is preferably greater than or equal to 0.05 and less than or equal to 2, further preferably greater than or equal to 0.1 and less than or equal to 1.5, and still further preferably greater than or equal to 0.1 and less than or equal to 0.9, for example.

When the number of cobalt atoms included in the positive electrode active material 200 is taken as 100, the relative value of the number of magnesium atoms is preferably greater than or equal to 0.1 and less than or equal to 6, and further preferably greater than or equal to 0.3 and less than or equal to 3, for example.

When the number of magnesium atoms included in the positive electrode active material 200 is taken as 1, the relative value of the number of fluorine atoms is preferably greater than or equal to 2 and less than or equal to 3.9, for example.

### [Mixture Ratio]

The mixture ratio of the positive electrode active material 100 and the positive electrode active material 200 is preferably a mixture ratio with which powder packing density (hereinafter referred to as PPD) is heightened, in which case the capacity per volume of a secondary battery can be increased.

A powder with the weight W is filled in a pellet dice and gradually pressed uniaxially up to a certain pressure, and the PPD is calculated from the volume V under that pressure (Formula (1) below).

[Formula 1]

PPD=W/V(g/cc) (1)

In this embodiment and examples, a powder of 1.2 g (W) is filled in a pellet dice with a diameter of 10 mm and pressed uniaxially at 50 kN for 30 seconds and the PPD is calculated from the volume (V) after the uniaxial pressing.

In the group of particles in which the positive electrode active material 100 and the positive electrode active material 200 are mixed, the proportion of the positive electrode active material 100 is preferably greater than or equal to 5 weight % and less than or equal to 30 weight % because the PPD is heightened with such a proportion; the proportion is further preferably greater than or equal to 10 weight % and less than or equal to 20 weight %.

### [Crystal Structure]

The positive electrode active material 100 and the positive electrode active material 200 preferably have a pseudo-spinel crystal structure when high-voltage charge is performed. A pseudo-spinel crystal structure is described below.

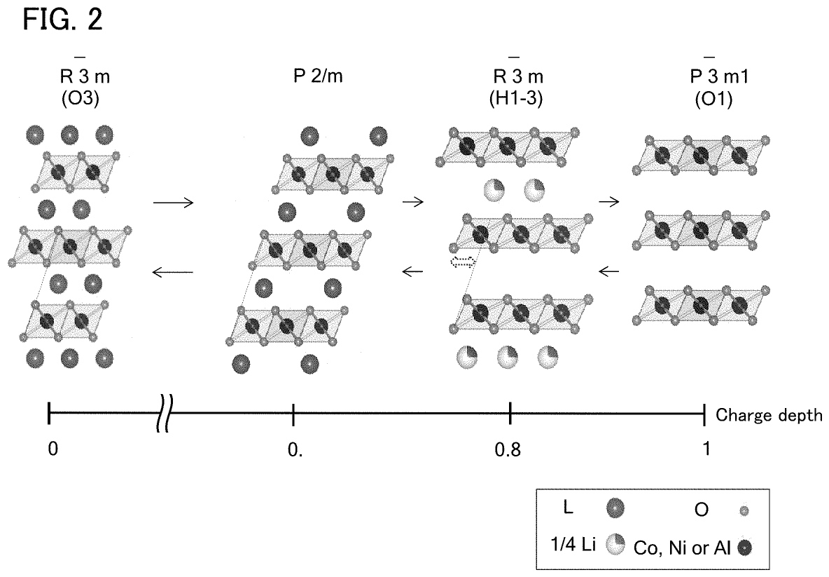

A positive electrode active material shown in FIG. 2 is lithium cobalt oxide (LiCoO₂) in which magnesium, nickel, aluminum, or the like is not added. As described in Non-Patent Document 1, Non-Patent Document 2, and the like, the crystal structure of lithium cobalt oxide shown in FIG. 2 changes depending on the charge depth.

As shown in FIG. 2, lithium cobalt oxide with a charge depth of 0 (discharged state) includes a region having a crystal structure of the space group R-3m, and includes three CoO₂ layers in a unit cell. Thus, this crystal structure is referred to as an O3-type crystal structure in some cases. Note that the CoO₂ layer has a structure in which octahedral geometry with oxygen hexacoordinated to cobalt continues on a plane in the edge-sharing state.

When the charge depth is 1, LiCoO₂ has the crystal structure of the space group P-3m1, and one CoO₂ layer exists in a unit cell. Thus, this crystal structure is referred to as an O1-type crystal structure in some cases.

Moreover, lithium cobalt oxide when the charge depth is approximately 0.88 has the crystal structure of the space group R-3m. This structure can also be regarded as a structure in which CoO₂ structures such as P-3m1 (O1) and LiCoO₂ structures such as R-3m (O3) are alternately stacked. Thus, this crystal structure is referred to as an H1-3 type crystal structure in some cases. Note that the number of cobalt atoms per unit cell in the actual H1-3 type crystal structure is twice as large as that of cobalt atoms per unit cell in other structures. However, in this specification including FIG. 2, the c-axis of the H1-3 type crystal structure is half that of the unit cell for easy comparison with the other structures.

For the H1-3 type crystal structure, as disclosed in Non-Patent Document 3, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). O₁ and O₂ are each an oxygen atom. In this manner, the H1-3 type crystal structure is represented by a unit cell including one cobalt and two oxygen. Meanwhile, the pseudo-spinel crystal structure of one embodiment of the present invention is preferably represented by a unit cell including one cobalt and one oxygen, as described later. This means that the symmetry of cobalt and oxygen differs between the pseudo-spinel structure and the H1-3 type structure, and the amount of change from the O3 structure is smaller in the pseudo-spinel structure than in the H1-3 type structure. A preferred unit cell for representing a crystal structure in a positive electrode active material is selected such that the value of GOF (good of fitness) is smaller in the Rietveld analysis of XRD, for example.

When charge with a high voltage of 4.6 V or higher based on the redox potential of a lithium metal or charge with a large charge depth of 0.8 or more and discharge are repeated, the crystal structure of lithium cobalt oxide changes (i.e., an unbalanced phase change occurs) repeatedly between the H1-3 type crystal structure and the R-3m (O3) structure in a discharged state.

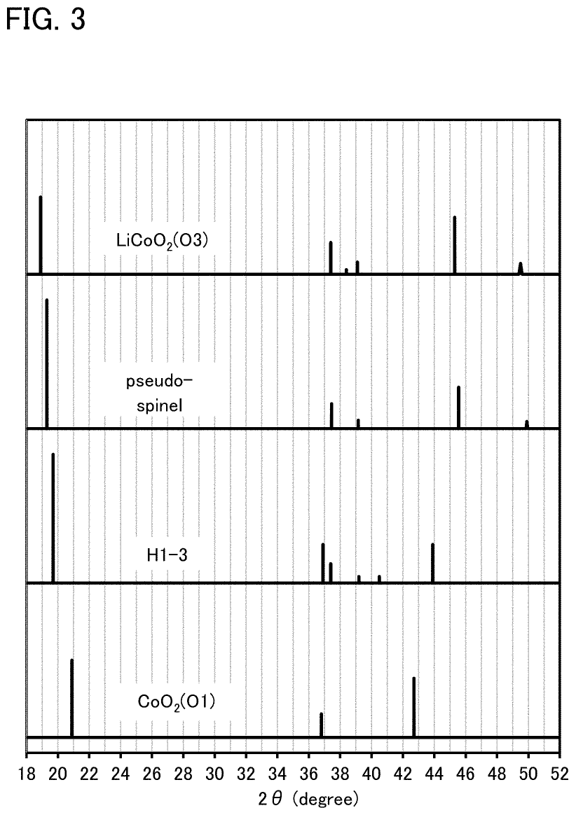

However, there is a large deviation in the position of the CoO₂ layer between these two crystal structures. As indicated by the dotted lines and the arrows in FIG. 3, the CoO₂ layer in the H1-3 type crystal structure greatly shifts from that in R-3m (O3). Such a dynamic structural change might adversely affect the stability of the crystal structure.

A difference in volume is also large. The H1-3 type crystal structure and the O3 type crystal structure in a discharged state that contain the same number of cobalt atoms have a difference in volume of 3.0% or more.

In addition, a structure in which CoO₂ layers are continuous, such as P-3m1 (O1), included in the H1-3 type crystal structure is highly likely to be unstable.

Thus, the repeated high-voltage charge and discharge break the crystal structure of lithium cobalt oxide. The break of the crystal structure degrades the cycle performance. This is probably because the break of the crystal structure reduces sites where lithium can stably exist and makes it difficult to insert and extract lithium.

An example of a crystal structure of the positive electrode active material 100 and the positive electrode active material 200 of one embodiment of the present invention before and after charge and discharge is shown in FIG. 1.

The crystal structure with a charge depth of 0 (in the discharged state) in FIG. 1 is R-3m (O3) as in FIG. 2. However, when having a charge depth of the adequately charged state, the positive electrode active material 100 and the positive electrode active material 200 preferably have a crystal with a structure different from the H1-3 crystal structure. This structure belongs to the space group R-3m, and is not a spinel crystal structure but a structure in which oxygen is hexacoordinated to ions of cobalt, magnesium, or the like and the cation arrangement has symmetry similar to that of the spinel crystal structure. This structure is thus referred to as the pseudo-spinel crystal structure in this specification and the like. Note that although the indication of lithium is omitted in the diagram of the pseudo-spinel crystal structure shown in FIG. 1 to explain the symmetry of cobalt atoms and the symmetry of oxygen atoms, a lithium of 20 atomic % or less, for example, with respect to cobalt practically exists between the CoO₂ layers. In addition, in both the O3 type crystal structure and the pseudo-spinel crystal structure, a slight amount of magnesium preferably exists between the CoO₂ layers, i.e., in lithium sites. In addition, a slight amount of halogen such as fluorine preferably exists in oxygen sites at random.

Note that in the pseudo-spinel crystal structure, oxygen is tetracoordinated to a light element such as lithium in some cases; also in that case, the ion arrangement has symmetry similar to that of the spinel structure.

The pseudo-spinel crystal structure can also be regarded as a crystal structure that contains Li between layers at random but is similar to a CdCl₂ type crystal structure. The crystal structure similar to the CdCl₂ type crystal structure is close to a crystal structure of lithium nickel oxide when charged up to a charge depth of 0.94 (Li_{0.06}NiO₂); however, pure lithium cobalt oxide or a layered rock-salt positive electrode active material containing a large amount of cobalt is known not to have this crystal structure in general.

Anions of a layered rock-salt crystal and anions of a rock-salt crystal have a cubic close-packed structure (face-centered cubic lattice structure). Anions of a pseudo-spinel crystal are also presumed to have a cubic close-packed structure. When the pseudo-spinel crystal is in contact with the layered rock-salt crystal and the rock-salt crystal, there is a crystal plane at which orientations of cubic close-packed structures composed of anions are aligned. Note that a space group of the layered rock-salt crystal and the pseudo-spinel crystal is R-3m, which is different from a space group Fm-3m of a rock-salt crystal (a space group of a general rock-salt crystal) and a space group Fd-3m of a rock-salt crystal (a space group of a rock-salt crystal having the simplest symmetry); thus, the Miller index of the crystal plane satisfying the above conditions in the layered rock-salt crystal and the pseudo-spinel crystal is different from that in the rock-salt crystal. In this specification, a state where the orientations of the cubic close-packed structures composed of anions in the layered rock-salt crystal, the pseudo-spinel crystal, and the rock-salt crystal are aligned is sometimes referred to as a state where crystal orientations are substantially aligned.

When high-voltage charge is performed and a large amount of lithium is extracted, a pseudo-spinel crystal structure reduces a change in the crystal structure as compared to a conventional positive electrode active material. As shown by dotted lines in FIG. 1, for example, CoO₂ layers hardly deviate in the crystal structures.

More specifically, when the positive electrode active material 100 and the positive electrode active material 200 have the pseudo-spinel crystal structure in high-voltage charging, the structure has high stability. For example, at charge voltage that makes the conventional positive electrode active material shown in FIG. 2 have the H1-3 type crystal structure, for example, at a voltage of approximately 4.6 V with reference to the potential of lithium metal, there is a charge voltage region where the positive electrode active material 100 can maintain the R-3m (O3) crystal structure. Moreover, in a higher charge voltage region, for example, at voltages of approximately 4.65 V to 4.7 V with reference to the potential of lithium metal, there is a region within which the pseudo-spinel crystal structure can be obtained. At a much higher charge voltage, the H1-3 type crystal is eventually observed in some cases. In the case where graphite, for instance, is used as a negative electrode active material in a secondary battery, a charge voltage region where the R-3m (O3) crystal structure can be maintained exists when the voltage of the secondary battery is, for example, higher than or equal to 4.3 V and lower than or equal to 4.5 V. In a higher charge voltage region, for example, at a voltage higher than or equal to 4.35 V and lower than or equal to 4.55 V with reference to the potential of a lithium metal, there is a region within which the pseudo-spinel crystal structure can be obtained.

Thus, in the positive electrode active material 100 and the positive electrode active material 200, the crystal structure is unlikely to be broken even when charge and discharge are repeated at high voltage.

Note that in the unit cell of the pseudo-spinel crystal structure, coordinates of cobalt and oxygen can be represented by Co (0, 0, 0.5) and O (0, 0, x) within the range of 0.20≤x≤0.25.

A slight amount of additive substances, such as magnesium, existing between the CoO₂ layers, i.e., in lithium sites at random, has an effect of inhibiting a deviation in the CoO₂ layers in high-voltage charging. Thus, the existence of magnesium between the CoO₂ layers makes it easier to obtain the pseudo-spinel crystal structure. Therefore, magnesium is preferably distributed over the entire particle of the positive electrode active material 100. In addition, to distribute magnesium over the entire particle, heat treatment is preferably performed in the formation process of the positive electrode active material 100 and the positive electrode active material 200.

However, cation mixing occurs when the heat treatment temperature is excessively high, so that magnesium is highly likely to enter the cobalt sites. Magnesium in the cobalt sites does not have the effect of maintaining the R-3m structure in high-voltage charging. Furthermore, when the heat treatment temperature is excessively high, adverse effects such as reduction of cobalt to have a valence of two and transpiration of lithium are concerned.

In view of the above, a halogen compound such as a fluorine compound is preferably added to lithium cobalt oxide before the heat treatment for distributing magnesium over whole particles. The addition of the halogen compound depresses the melting point of lithium cobalt oxide. The depression of the melting point makes it easier to distribute magnesium over whole particles at a temperature at which the cation mixing is unlikely to occur. Furthermore, it is expected that the existence of the fluorine compound can improve corrosion resistance to hydrofluoric acid generated by decomposition of an electrolyte solution.

When the magnesium concentration is higher than a predetermined value, the effect of stabilizing a crystal structure becomes small in some cases. This is probably because magnesium enters the cobalt sites in addition to the lithium sites.

### <Charge Method and XRD Measurement Method>

Whether a composite oxide has a pseudo-spinel crystal structure in high-voltage charging can be determined by, for example, forming a coin cell (CR2032 type, diameter: 20 mm, and height: 3.2 mm) using a lithium as a counter electrode, charging the coin cell, and estimating the crystal structure by XRD.

More specifically, a positive electrode current collector made of aluminum foil that is coated with slurry in which a positive electrode active material, a conductive additive, and a binder are mixed can be used as a positive electrode. At this time, when the positive electrode active material layer is too thin, a signal of the aluminum foil is detected by XRD; thus, the positive electrode active material layer preferably has a certain amount of thickness. A positive electrode that is not pressed after the coating is preferably used, in which case peaks other than a peak derived from the (003) plane at 2θ of approximately 18° to 20° can easily be observed.

A lithium metal can be used for the counter electrode. Note that when a material other than the lithium metal is used for the counter electrode, the voltage of a secondary battery differs from the potential of the positive electrode. Unless otherwise specified, voltages and potentials in this specification and the like refer to the potentials of a positive electrode.

As an electrolyte contained in the electrolyte solution, 1 mol/L of lithium hexafluorophosphate (LiPF₆) is used. As a solvent, a solution in which ethylene carbonate (EC) and diethyl carbonate (DEC) are mixed at EC:DEC=3:7 (volume ratio) can be used.

As a separator, 25-μm-thick polypropylene can be used.

A positive electrode can and a negative electrode can that are formed using stainless steel (SUS) can be used as a positive electrode can and a negative electrode can.

The coin cell formed under the above conditions is charged with constant current at 4.6 V and 0.2 C and then charged with constant voltage until the current value reaches 0.02 C. After constant current discharging at 0.2 C to reach 2.5 V, constant current charging is performed again at 4.6 V and 0.2 C; then, constant voltage charging is performed until the current value reaches 0.02 C. Note that here, 1 C is set to 200 mA/g. The temperature is set to 25° C. After the charging is performed in this manner, the coin cell is disassembled in a glove box with an argon atmosphere and the electrolyte solution is removed by washing with a solvent such as DMC to take out the positive electrode, whereby the high-voltage charged positive electrode active material can be obtained. In order to inhibit reaction with components in the external world, the positive electrode active material is preferably hermetically sealed in an argon atmosphere when subjected to various analyses later. For example, XRD can be performed on the positive electrode active material enclosed in an airtight container with an argon atmosphere.

It is preferable that an XRD apparatus be set for powder samples, and the heights of the samples be set in accordance with the measurement surface required by the apparatus. In addition, the positive electrode samples are preferably set to be flat without any curve. Specifically, the electrodes can be measured while being attached to a double-faced tape (nonwoven fabric coated with an adhesive, for general stationery use) on a glass board and enclosed in an airtight cell.

### <XRD Pattern>

FIG. 3 shows ideal powder XRD patterns with CuKα1 rays that are calculated from models of a pseudo-spinel crystal structure and an H1-3 type crystal structure. For comparison, FIG. 3 also shows ideal XRD patterns calculated from the crystal structures of LiCoO₂ (O3) with a charge depth of 0 and CoO₂ (O1) with a charge depth of 1. Note that the patterns of LiCoO₂ (O3) and CoO₂ (O1) were made from crystal structure data obtained from ICSD (Inorganic Crystal Structure Database) (see Non-Patent Document 5) using Reflex Powder Diffraction, which is a module of Materials Studio (BIOVIA). The range of 2θ was from 15° to 75°, Step size was 0.01, the wavelength λ1 was 1.540562×10⁻¹⁰ m, λ2 was not set, and Monochromator was a single monochromator. The pattern of the H1-3 type crystal structure was made from the crystal structure data described in Non-Patent Document 3 in a similar manner. The pattern of the pseudo-spinel crystal structure was estimated from the XRD pattern of the positive electrode active material of one embodiment of the present invention, the crystal structure was fitted with TOPAS ver. 3 (crystal structure analysis software manufactured by Bruker Corporation), and XRD patterns were made in a manner similar to those of other structures.

As shown in FIG. 3, in the pseudo-spinel crystal structure, diffraction peaks appear at 2θ=19.30±0.20° (greater than or equal to 19.10° and less than or equal to 19.50°) and 2θ=45.55±0.10° (greater than or equal to 45.45° and less than or equal to 45.65°). More specifically, sharp diffraction peaks appear at 2θ=19.30±0.10° (greater than or equal to 19.20° and less than or equal to 19.40°) and 2θ=45.55±0.05° (greater than or equal to 45.50° and less than or equal to 45.60). However, in the H1-3 type crystal structure and CoO₂ (P-3m1, O1), peaks at these positions do not appear. Thus, the peaks at 2θ=19.30±0.20° and 2θ=45.55±0.10° in the high-voltage charged state can be the features of the pseudo-spinel crystal structure.

It other words, the positions where the XRD diffraction peaks appear are close in the crystal structure with a charge depth of 0 and the crystal structure in the high-voltage charged state. More specifically, a difference in the positions of two or more, further preferably three or more of the main diffraction peaks between both of the crystal structures is 2θ=less than or equal to 0.7, further preferably 2θ=less than or equal to 0.5.

Note that although the positive electrode active material 100 and the positive electrode active material 200 of one embodiment of the present invention preferably have the pseudo-spinel crystal structure when being charged with high voltage, not all the particles necessarily have the pseudo-spinel crystal structure. The particles may have another crystal structure, or some of the particles may be amorphous. Note that when the XRD patterns are analyzed by the Rietveld analysis, the pseudo-spinel crystal structure preferably accounts for more than or equal to 50 wt %, further preferably more than or equal to 60 wt %, and still further preferably more than or equal to 66 wt %. The positive electrode active material in which the pseudo-spinel crystal structure accounts for more than or equal to 50 wt %, further preferably more than or equal to 60 wt %, and still further preferably more than or equal to 66 wt % can have sufficiently good cycle performance.

Even after 100 or more cycles of charge and discharge, the pseudo-spinel crystal structure preferably accounts for more than or equal to 35 wt %, further preferably more than or equal to 40 wt %, and still further preferably more than or equal to 43 wt % when the Rietveld analysis is performed.

The crystallite size of the pseudo-spinel crystal structure included in the positive electrode active material particle does not decrease to less than approximately one-tenth that of LiCoO₂ (O3) in the discharged state. Thus, a clear peak of the pseudo-spinel crystal structure can be observed after the high-voltage charge even under the same XRD measurement conditions as those of a positive electrode before the charge and discharge. In contrast, simple LiCoO₂ has a small crystallite size and a broad small peak even when it can have a structure part of which is similar to the pseudo-spinel crystal structure. The crystallite size can be calculated from the half width of the XRD peak.

<dQ/dVvsV Curve>

When the positive electrode active material of one embodiment of the present invention is discharged at a low rate of, for example, 0.2 C or less after high-voltage charge, a characteristic change in voltage appears just before the end of discharge, in some cases. This change can be clearly observed by the fact that at least one peak appears within the range of 3.5 V to 3.9 V in a dQ/dVvsV curve calculated from a discharge curve.

### [Forming Method of Positive Electrode Active Material 100]

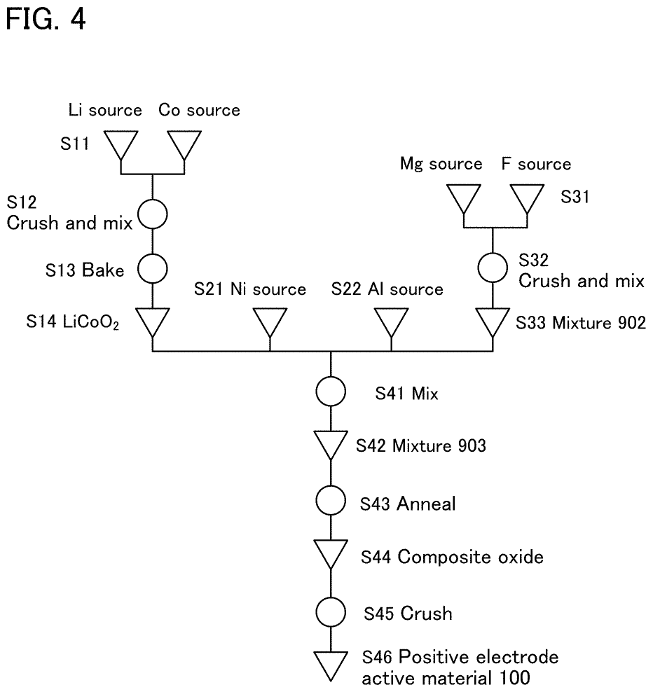

Next, an example of the forming method of the positive electrode active material 100 will be described with reference to FIG. 4. The positive electrode active material 100 is preferably formed by synthesizing lithium cobalt oxide, mixing a nickel source, an aluminum source, a magnesium source, and a fluorine source, and then performing heating. Crushing treatment is preferably performed after the heating.

### <Step S11: Preparation of Li Source and Co Source>

First, a lithium source and a cobalt source are prepared as starting materials. As the lithium source, for example, lithium carbonate or lithium fluoride can be used. As the cobalt source, for example, cobalt oxide can be used.

### <Step S12: Crushing and Mixing of Li Source and Co Source>

Next, the above starting materials are mixed. For example, a ball mill, a bead mill, or the like can be used for the mixing. When the ball mill is used, a zirconia ball can be used as media, for example.

The particle diameter of the mixed material influences the particle diameter of lithium cobalt oxide obtained after baking. Hence, in this step, the crushing and mixing are preferably performed in a ball mill device with an orbital radius of 75 mm and a spinning vessel radius of 20 mm at greater than or equal to 100 rpm and less than or equal to 300 rpm for approximately 12 hours.

### <Step 13: Baking>

Next, the materials mixed in Step 12 are heated. This step is referred to as baking or first heating in some cases. The heating is preferably performed at higher than or equal to 800° C. and lower than 1100° C., further preferably at higher than or equal to 900° C. and lower than or equal to 1000° C., and still further preferably at approximately 950° C. Excessively low temperature might result in insufficient decomposition and melting of the starting materials. In contrast, excessively high temperature might cause reduction of cobalt, evaporation of lithium, and the like, leading to a defect in which cobalt has a valence of two.

The heating time is preferably longer than or equal to 2 hours and shorter than or equal to 20 hours. The baking is preferably performed in an atmosphere such as dry air. For example, it is preferable that the heating be performed at 950° C. for 10 hours, the temperature rise be 200° C./h, and the flow rate of a dry atmosphere be 10 L/min. After that, the heated materials are cooled to room temperature. The temperature decreasing time from the holding temperature to room temperature is preferably longer than or equal to 10 hours and shorter than or equal to 50 hours, for example.

### <Step S14: LiCoO₂>

The materials heated in Step S13 are collected to give lithium cobalt oxide.

### <Step S21: Preparation of Ni Source>

Next, a nickel source is prepared. As the nickel source, for example, nickel hydroxide or nickel fluoride can be used.

### <Step S22: Preparation of Al Source>

Next, an aluminum source is prepared. As the aluminum source, for example, aluminum hydroxide or aluminum fluoride can be used.

### <Step S31: Preparation of Mg Source and F Source>

Next, a magnesium source and a fluorine source are prepared. As the aluminum source, for example, magnesium fluoride, magnesium hydroxide, or magnesium carbonate can be used. As the fluorine source, for example, lithium fluoride or magnesium fluoride can be used. That is, lithium fluoride can be used as both the lithium source and the fluorine source, and magnesium fluoride can be used as both the fluorine source and the magnesium source.

In this embodiment, lithium fluoride LiF is prepared as the fluorine source, and magnesium fluoride MgF₂ is prepared as the fluorine source and the magnesium source. When lithium fluoride LiF and magnesium fluoride MgF₂ are mixed at a molar ratio of approximately LiF:MgF₂=1:3, the effect of lowering the melting point becomes high. On the other hand, when the amount of lithium fluoride increases, excessive lithium might deteriorate cycle performance. Therefore, the molar ratio of lithium fluoride LiF to magnesium fluoride MgF₂ is preferably LiF:MgF₂=x:1 (0≤x≤1.9), further preferably LiF:MgF₂=x:1 (0.1≤x≤0.5), and still further preferably LiF:MgF₂=x:1 (x=the vicinity of 0.33). Note that in this specification and the like, the vicinity means a value greater than 0.9 times and smaller than 1.1 times a certain value.

In this embodiment, LiF and MgF₂ are mixed at a molar ratio of LiF:MgF₂=1:3 and a weight ratio of LiF:MgF₂=12.19:87.81.

In addition, in the case where the following crushing and mixing steps are performed by a wet process, a solvent is prepared. As the solvent, ketone such as acetone; alcohol such as ethanol or isopropanol; ether; dioxane; acetonitrile; N-methyl-2-pyrrolidone (NMP); or the like can be used. An aprotic solvent that hardly reacts with lithium is further preferably used. In this embodiment, acetone is used.

### <Step S32: Crushing and Mixing of Mg Source and F Source>

Next, the magnesium source and the fluorine source are crushed and mixed. Although the mixing can be performed by a dry process or a wet process, the wet process is preferable because the materials can be ground to a smaller size. For example, a ball mill, a bead mill, or the like can be used for the mixing. When the ball mill is used, a zirconia ball can be used as media, for example. It is preferable that the crushing and mixing steps be adequately performed to pulverize a mixture 902 of the magnesium source and the fluorine source.

In this embodiment, mixing and grinding are performed in a ball mill. More specifically, the magnesium source and the fluorine source are put in a ball mill container (zirconia pot manufactured by Ito Seisakusho with a capacitance of 45 mL) with a zirconia ball (1 mmϕ), 20 mL of dehydrated acetone is added thereto, and mixing and grinding are performed at 400 rpm for 12 hours.

### <Step S33: Mixture 902>

The materials crushed and mixed in Step S32 are collected to give the mixture 902.

In this embodiment, after Step S32, the zirconia ball and a suspension are classified using a sieve, and the suspension is dried on a hot plate at 50° C. for approximately 1 hour to 2 hours, whereby the mixture 902 is obtained.

When the particle size distribution of the mixture 902 is measured by, for example, a laser diffraction and scattering method, D₅₀ is preferably longer than or equal to 600 nm and shorter than or equal to 20 μm, further preferably longer than or equal to 1 μm and shorter than or equal to 10 μm, and still further preferably approximately 3.5 μm. When mixed with lithium cobalt oxide in a later step, the mixture 902 pulverized to such a small size is easily attached to a surface of a lithium cobalt oxide particle uniformly. Uniform attachment of the mixture 902 to the surface of lithium cobalt oxide particle is preferable because magnesium and halogen such as fluorine are easily distributed in a superficial portion of lithium cobalt oxide after heating.

### <Step S41: Mixing>

Next, lithium cobalt oxide, the nickel source, the aluminum source, and the mixture 902 are mixed. The mixing is preferably performed so that when the number of cobalt atoms included in lithium cobalt oxide is taken as 100, the relative value of the number of magnesium atoms included in the mixture 902 is preferably greater than or equal to 0.1 and less than or equal to 6, and further preferably greater than or equal to 0.3 and less than or equal to 3.

The condition of the mixing in Step S41 is preferably milder than that of the mixing in Step S32 not to damage the lithium cobalt oxide particle. For example, a condition with a lower rotation frequency or shorter time than the mixing in Step S32 is preferable. In addition, it can be said that the dry process has a milder condition than the wet process. For example, a ball mill, a bead mill, or the like can be used for the mixing. When the ball mill is used, a zirconia ball is preferably used as media, for example.

### <Step S42: Mixture 903>

The materials mixed in the above step are collected to give a mixture 903.

### <Step S43: Annealing>

Next, the mixture 903 is heated. This step is referred to as annealing or second heating in some cases to be distinguished from the heating step (Step S13) performed before.

The annealing is preferably performed at an appropriate temperature for an appropriate time. The appropriate temperature and time depend on the conditions such as the particle size and the composition of the lithium cobalt oxide particle in Step S14. In the case where the particle size is small, the annealing is preferably performed at a lower temperature or for a shorter time than the case where the particle size is large, in some cases. When the annealing is performed at too high a temperature or for too long a time, the particle is sintered in some cases.

The positive electrode active material 100 formed in this embodiment has a local maximum value at longer than or equal to 1 μm and shorter than or equal to 10 μm when the particle size distribution is measured, i.e., the positive electrode active material 100 has a relatively small particle diameter; thus, the annealing temperature is preferably higher than or equal to 600° C. and lower than or equal to 950° C. The annealing time is preferably longer than or equal to 1 hour and shorter than or equal to 10 hours, and further preferably approximately 2 hours. In this embodiment, annealing is performed at 800° C. for 2 hours.

The temperature decreasing time after the annealing is preferably longer than or equal to 10 hours and shorter than or equal to 50 hours, for example.

When the mixture 903 is annealed, a material having a low melting point (e.g., lithium fluoride included in the mixture 902, which has a melting point of 848° C.) in the mixture 903 is probably melted first and distributed to the superficial portion of the lithium cobalt oxide particle. Next, the existence of the melted material decreases the melting points of other materials, presumably resulting in melting of the other materials. For example, magnesium fluoride (melting point: 1263° C.) is presumably melted and distributed to the superficial portion of the lithium cobalt oxide particle. In other words, lithium fluoride serves as a flux.

Elements that are included in the mixture 902 and distributed to the superficial portion probably form a solid solution in lithium cobalt oxide.

The elements included in the mixture 902 are diffused faster in the superficial portion and the vicinity of the grain boundary than inside the composite oxide particle. Thus, the concentrations of magnesium and fluorine in the superficial portion and the vicinity of the grain boundary are higher than those of magnesium and fluorine inside the composite oxide particle.

### <Step S44: Composite Oxide>

The material heated in Step S43 is collected to give a composite oxide containing lithium, cobalt, nickel, aluminum, magnesium, oxygen, and fluorine.

### <Step S45: Crushing>

The composite oxide that has been subjected to annealing sometimes includes a secondary particle with primary particles aggregated, and thus is subjected to crushing treatment here. The crushing can be performed in a ball mill, a thin-film spin system high-speed mixer, or the like. In the case where the crushing is performed in a ball mill, the crushing and mixing are preferably performed in, for example, a ball mill device with an orbital radius of 75 mm and a spinning vessel radius of 20 mm at greater than or equal to 80 rpm and less than or equal to 150 rpm for approximately 2 hours. The use of the thin-film spin system high-speed mixer for crushing is preferable because primary particles are unlikely to be further ground. Such a crushing step after the annealing can reduce the particle diameter.

### <Step S46: Positive Electrode Active Material 100>

The material crushed in Step S45 is collected to give the positive electrode active material 100.

### [Forming Method of Positive Electrode Active Material 200]

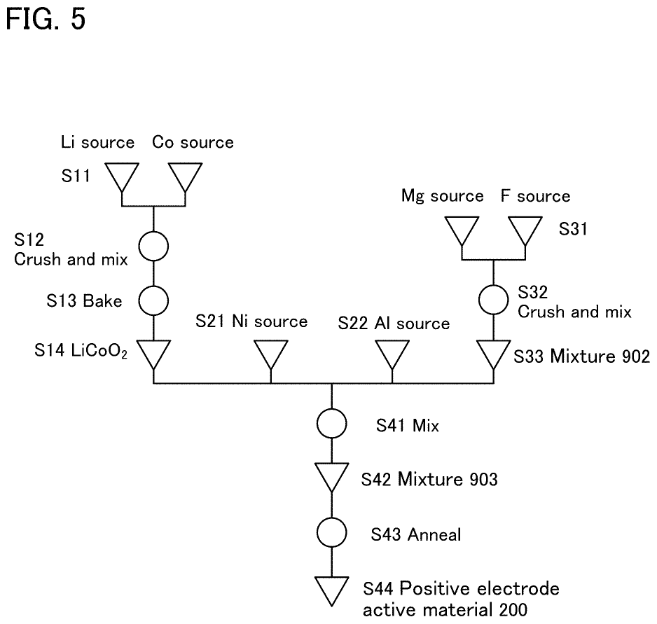

Next, an example of the forming method of the positive electrode active material 200 will be described with reference to FIG. 5. The positive electrode active material 200 can be formed by mixing a nickel source, an aluminum source, a magnesium source, and a fluorine source to lithium cobalt oxide, and then performing heating.

### <Step S11 to Step S14>

As in the forming method of the positive electrode active material 100 described in FIG. 4, a lithium source and a cobalt source are mixed and baked, whereby lithium cobalt oxide is formed. The particle diameter of the starting material influences the particle diameter of lithium cobalt oxide obtained after baking; hence, when a ball mill is used in Step 12, the crushing and mixing are preferably performed in a ball mill device with an orbital radius of 75 mm and a spinning vessel radius of 20 mm at greater than or equal to 80 rpm and less than or equal to 300 rpm for approximately 2 hours.

Lithium cobalt oxide synthesized in advance may be used. In that case, Step S11 to Step S13 can be omitted.

For example, as lithium cobalt oxide synthesized in advance, a lithium cobalt oxide particle (product name: CELLSEED C-10N) manufactured by NIPPON CHEMICAL INDUSTRIAL CO., LTD. can be used. This is lithium cobalt oxide in which the average particle diameter (D₅₀) is approximately 12 μm, and in the impurity analysis by a glow discharge mass spectroscopy method (GD-MS), the magnesium concentration and the fluorine concentration are less than or equal to 50 ppm wt, the calcium concentration, the aluminum concentration, and the silicon concentration are less than or equal to 100 ppm wt, the nickel concentration is less than or equal to 150 ppm wt, the sulfur concentration is less than or equal to 500 ppm wt, the arsenic concentration is less than or equal to 1100 ppm wt, and the concentrations of elements other than lithium, cobalt, and oxygen are less than or equal to 150 ppm wt.

Alternatively, a lithium cobalt oxide particle (product name: CELLSEED C-5H) manufactured by NIPPON CHEMICAL INDUSTRIAL CO., LTD. can be used. This is lithium cobalt oxide in which the average particle diameter (D₅₀) is approximately 6.5 μm, and the concentrations of elements other than lithium, cobalt, and oxygen are approximately equal to or less than those of C-10N in the impurity analysis by GD-MS.

In this embodiment, cobalt is used as a transition metal, and the lithium cobalt oxide particle synthesized in advance (CELLSEED C-10N manufactured by NIPPON CHEMICAL INDUSTRIAL CO., LTD.) is used.

### <Step S21 and Step S22>

As in FIG. 4, a nickel source and an aluminum source are prepared.

### <Step S31 to Step S33>

As in FIG. 4, a magnesium source and fluorine are crushed and mixed to give the mixture 902.

### <Step S41 and Step S42>

As in FIG. 4, lithium cobalt oxide, the nickel source, the aluminum source, and the mixture 902 are mixed to give the mixture 903.

### <Step S43: Annealing>

Next, the mixture 903 is heated. Since the positive electrode active material 200 has a larger particle diameter than the positive electrode active material 100, appropriate annealing temperature and time for the positive electrode active material 200 are different from those for the positive electrode active material 100.

The annealing temperature is preferably higher than or equal to 600° C. and lower than or equal to 950° C., for example. The annealing time is preferably longer than or equal to 3 hours, further preferably longer than or equal to 10 hours, and still further preferably longer than or equal to 60 hours, for example. In this embodiment, annealing is performed at higher than or equal to 800° C. and lower than or equal to 850° C. for longer than or equal to 2 hours and shorter than or equal to 10 hours.

### <Step S44: Positive Electrode Active Material 200>

The material annealed in Step S43 is collected to give the positive electrode active material 200.

This embodiment can be implemented in appropriate combination with the other embodiments.

### Embodiment 2

Described in this embodiment are examples of materials and structures that can be used for a secondary battery containing the positive electrode active material described in the above embodiment. In addition, a fabrication method of parts of the structures will be described.

### Structure Example 1 of Secondary Battery

Hereinafter, a secondary battery in which a positive electrode, a negative electrode, and an electrolyte solution are wrapped in an exterior body is described as an example.

### [Positive Electrode]

The positive electrode includes a positive electrode active material layer and a positive electrode current collector.

### <Positive Electrode Active Material Layer>

The positive electrode active material layer contains at least a positive electrode active material. The positive electrode active material layer may contain, in addition to the positive electrode active material, other materials such as a coating film of the active material surface, a conductive additive, and a binder.

As the positive electrode active material, the positive electrode active material 100 or a mixture of the positive electrode active material 100 and the positive electrode active material 200 described in the above embodiment can be used.

In the case where the mixture of the positive electrode active material 100 and the positive electrode active material 200 is used, the positive electrode active material 100 is preferably greater than or equal to 5 weight % and less than or equal to 30 weight % of the total, and further preferably greater than or equal to 10 weight % and less than or equal to 20 weight %. A secondary battery including the positive electrode active material 100 or the mixture of the positive electrode active material 100 and the positive electrode active material 200 described in the above embodiment can have high capacity and excellent cycle performance.

Examples of the conductive additive include a carbon material, a metal material, and a conductive ceramic material. Alternatively, a fiber material may be used as the conductive additive. The content of the conductive additive to the total amount of the active material layer is preferably greater than or equal to 1 wt % and less than or equal to 10 wt %, and further preferably greater than or equal to 1 wt % and less than or equal to 5 wt %.

A network for electric conduction can be formed in the active material layer by the conductive additive. The addition of the conductive additive to the active material layer increases the electric conductivity of the active material layer.

Examples of the conductive additive include natural graphite, artificial graphite such as mesocarbon microbeads, and carbon fiber. As carbon fiber, mesophase pitch-based carbon fiber and isotropic pitch-based carbon fiber can be used. Furthermore, as carbon fiber, carbon nanofiber and carbon nanotube can be used. Carbon nanotube can be formed by, for example, a vapor deposition method. Other examples of the conductive additive include carbon materials such as carbon black (e.g., acetylene black (AB)), graphite (black lead) particles, graphene, multilayer graphene, reduced graphene oxide, and fullerene. Alternatively, metal powder or metal fibers of copper, nickel, aluminum, silver, gold, or the like, a conductive ceramic material, or the like can be used.

A plurality of the above materials may be used in combination for the conductive additive.

As the binder, a rubber material such as styrene-butadiene rubber (SBR), styrene-isoprene-styrene rubber, acrylonitrile-butadiene rubber, butadiene rubber, or ethylene-propylene-diene copolymer can be used, for example. Alternatively, fluororubber can be used as the binder.

For the binder, for example, water-soluble polymers are preferably used. As the water-soluble polymers, for example, a polysaccharide can be used. As the polysaccharide, for example, a cellulose derivative such as carboxymethyl cellulose (CMC), methyl cellulose, ethyl cellulose, hydroxypropyl cellulose, diacetyl cellulose, or regenerated cellulose or starch can be used. It is further preferable that such water-soluble polymers be used in combination with any of the above rubber materials.

Alternatively, as the binder, a material such as polystyrene, poly(methyl acrylate), poly(methyl methacrylate) (polymethyl methacrylate, PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

A plurality of the above materials may be used in combination for the binder.

For example, a material having a significant viscosity modifying effect and another material may be used in combination. For example, a rubber material or the like has high adhesion or high elasticity but may have difficulty in viscosity modification when mixed in a solvent. In such a case, a rubber material or the like is preferably mixed with a material having a significant viscosity modifying effect, for example. As a material having a significant viscosity modifying effect, for example, a water-soluble polymer is preferably used. An example of a water-soluble polymer having an especially significant viscosity modifying effect is the above-mentioned polysaccharide; for example, a cellulose derivative such as carboxymethyl cellulose (CMC), methyl cellulose, ethyl cellulose, hydroxypropyl cellulose, diacetyl cellulose, or regenerated cellulose, or starch can be used.

Note that a cellulose derivative such as carboxymethyl cellulose obtains a higher solubility when converted into a salt such as a sodium salt or an ammonium salt of carboxymethyl cellulose, and accordingly, easily exerts an effect as a viscosity modifier. The high solubility can also increase the dispersibility of an active material and other components in the formation of slurry for an electrode. In this specification, cellulose and a cellulose derivative used as a binder of an electrode include salts thereof.

A fluorine-based resin has an advantage in high mechanical strength, high chemical resistance, high heat resistance, and the like. Note that PVDF that is a fluorine-based resin particularly has excellent characteristics among fluorine-based resins; it has high mechanical strength, is easy to process, and has high heat resistance.

Meanwhile, when the slurry formed in coating the active material layer is alkaline, PVDF might be gelled. Alternatively, PVDF might be insolubilized. Gelling or insolubilization of a binder might decrease the adhesion between a current collector and an active material layer. The use of the positive electrode active material of one embodiment of the present invention can decrease pH of the slurry and accordingly can inhibit gelling or insolubilization in some cases, which is preferable.

### <Positive Electrode Current Collector>

The positive electrode current collector can be formed using a material that has high conductivity, such as a metal like stainless steel, gold, platinum, aluminum, and titanium, or an alloy thereof. It is preferable that a material used for the positive electrode current collector not dissolve at the potential of the positive electrode. Alternatively, it is possible to use an aluminum alloy to which an element that improves heat resistance, such as silicon, titanium, neodymium, scandium, or molybdenum, is added. Still alternatively, the positive electrode current collector may be formed using a metal element that forms silicide by reacting with silicon. Examples of the metal element that forms silicide by reacting with silicon include zirconium, titanium, hafnium, vanadium, niobium, tantalum, chromium, molybdenum, tungsten, cobalt, and nickel. The current collector can have any of various shapes including a foil-like shape, a plate-like shape (sheet-like shape), a net-like shape, a punching-metal shape, and an expanded-metal shape. The current collector preferably has a thickness of greater than or equal to 5 μm and less than or equal to 30 μm.

A current collector subjected to surface treatment may also be used. Examples of the surface treatment include corona discharge treatment, plasma treatment, and undercoat treatment. Here, the undercoat refers to a film formed over a current collector before application of slurry onto the current collector for the purpose of reducing the interface resistance between an active material layer and the current collector or increasing the adhesion between the active material layer and the current collector. Note that the undercoat is not necessarily formed in a film shape, and may be formed in an island shape. In addition, the undercoat may serve as an active material to have capacity. For the undercoat, a carbon material can be used, for example. Examples of the carbon material include graphite, carbon black such as acetylene black and ketjen black (registered trademark), and a carbon nanotube.

### [Method for Fabricating Positive Electrode]

An example of a method for fabricating a positive electrode including the positive electrode active material 100 or the mixture of the positive electrode active material 100 and the positive electrode active material 200 of one embodiment of the present invention is a method in which slurry containing a positive electrode active material is formed and the slurry is applied to the positive electrode current collector. An example of the method for forming and applying slurry will be described below.

The mixture ratio of the positive electrode active material, the conductive additive, and the binder may be the positive electrode active material: the conductive additive: the binder=95:3:2 (weight ratio), the positive electrode active material: the conductive additive: the binder=97:1.5:1.5 (weight ratio), or other mixture ratio.

A solvent used for formation of the slurry is preferably a polar solvent. For example, water, methanol, ethanol, acetone, tetrahydrofuran (THF), dimethylformamide (DMF), N-methylpyrrolidone (NMP), dimethyl sulfoxide (DMSO), or a mixed solution of two or more of the above can be used. In this embodiment, NMP is used.

A mixer is preferably used for formation of the slurry; for example, a planetary centrifugal mixer (ARE-310, THINKY CORPORATION) can be used. Note that when the total amount of binder and solvent is put and mixed in the mixer at a time, a cluster of particles is generated to make uniform mixing difficult. Hence, it is preferable that a kneading step of a small amount of binder and solvent be performed first, and then the remaining binder and solvent be mixed.

Specifically, the following steps are preferably performed. First, the binder is dissolved in the solvent to form a binder solution of 5 wt %. Next, part of the binder solution, which is measured so as to contain 35% to 50% of the actual binder, is added in the mixer. Then, the total amount of positive electrode active material and conductive additive is added in the mixer and kneaded at 2000 rpm for 3 minutes. At this time, the binder solution preferably has such an amount as to form a clay-like mixture.

After the mixture is collected with a spatula or the like, it is kneaded again in the mixer at 2000 rpm for 3 minutes. This process is repeated 8 times.

Next, the remaining binder solution and solvent is added in the mixer and kneaded at 2000 rpm for 3 minutes.

The formation of the slurry in these steps can offer a smooth slurry with few clusters of particles.

A 20-μm-thick aluminum foil is used as the current collector and the slurry is applied to the current collector; then, the solvent is volatilized. Drying can be performed at 80° C. for one hour using, for example, a ventilation dryer.

After that, pressure application is preferably performed in a calender roll device (mini-calender for testing (MSC-169), Yuri Roll Machinery Co., Ltd.) at a press temperature of 120° C. and a press line pressure of 210 kN/m, followed by further pressure application at 1467 kN/m to make a cathode, so that the positive electrode is obtained. The high pressure pressing after the low pressure pressing can reduce damage on the positive electrode active material and easily achieve high density.

The positive electrode may be dried again after the pressing. In that case, the drying is desirably performed in a vacuum at 120° C. for approximately 10 hours. The temperature at this time should not exceed the melting point of PVDF. Too high a temperature might decrease the strength of the positive electrode.

### [Negative Electrode]

The negative electrode includes a negative electrode active material layer and a negative electrode current collector. The negative electrode active material layer may contain a conductive additive and a binder.

### <Negative Electrode Active Material>

As the negative electrode active material, for example, an alloy-based material or a carbon-based material can be used.

For the negative electrode active material, an element that enables charge-discharge reactions by an alloying and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon and silicon in particular has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge-discharge reactions by an alloying and a dealloying reaction with lithium and a compound containing the element, for example, may be referred to as an alloy-based material.

In this specification and the like, SiO refers, for example, to silicon monoxide. Note that SiO can alternatively be expressed as SiOx. Here, x preferably has an approximate value of 1. For example, x is preferably more than or equal to 0.2 and less than or equal to 1.5, and further preferably more than or equal to 0.3 and less than or equal to 1.2.

As the carbon-based material, graphite, graphitizing carbon (soft carbon), non-graphitizing carbon (hard carbon), carbon nanotube, graphene, carbon black, and the like may be used.

Examples of graphite include artificial graphite and natural graphite. Examples of artificial graphite include meso-carbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it is relatively easy to have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are intercalated into graphite (when a lithium-graphite intercalation compound is formed). For this reason, a lithium-ion secondary battery can have a high operating voltage. In addition, graphite is preferable because of its advantages such as a relatively high capacity per unit volume, relatively small volume expansion, low cost, and higher level of safety than that of a lithium metal.

Alternatively, for the negative electrode active material, oxide such as titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), or molybdenum oxide (MoO₂) can be used.

Still alternatively, for the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of high charge and discharge capacity (900 mAh/g and 1890 mAh/cm³).

A composite nitride of lithium and a transition metal is preferably used, in which case the negative electrode active material contains lithium ions and thus can be used in combination with a positive electrode active material that does not contain lithium ions, such as V₂O₅ or Cr₃O₈. Note that in the case of using a material containing lithium ions as a positive electrode active material, the composite nitride of lithium and a transition metal can be used for the negative electrode active material by extracting the lithium ions contained in the positive electrode active material in advance.

Alternatively, a material that causes a conversion reaction can be used for the negative electrode active material. For example, a transition metal oxide that does not form an alloy with lithium, such as cobalt oxide (CoO), nickel oxide (NiO), or iron oxide (FeO), may be used. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive additive and the binder that can be included in the negative electrode active material layer, materials similar to those of the conductive additive and the binder that can be included in the positive electrode active material layer can be used.

### <Negative Electrode Current Collector>

For the negative electrode current collector, a material similar to that of the positive electrode current collector as well as copper or the like can be used. Note that a material that is not alloyed with carrier ions such as lithium is preferably used for the negative electrode current collector.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

Alternatively, the use of one or more ionic liquids (room temperature molten salts) that are less likely to burn and volatize as the solvent of the electrolyte solution can prevent a secondary battery from exploding or catching fire even when the secondary battery internally shorts out or the internal temperature increases owing to overcharge or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As an electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, and lithium bis(oxalate)borate (LiBOB) can be used, or two or more of these lithium salts can be used in an appropriate combination in an appropriate ratio.

The electrolyte solution used for a secondary battery is preferably highly purified and contains small numbers of dust particles and elements other than the constituent elements of the electrolyte solution (hereinafter, also simply referred to as “impurities”). Specifically, the weight ratio of impurities to the electrolyte solution is preferably less than or equal to 1%, further preferably less than or equal to 0.1%, and still further preferably less than or equal to 0.01%.

Furthermore, an additive agent such as vinylene carbonate (VC), propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of a material to be added in the whole solvent is, for example, higher than or equal to 0.1 wt % and lower than or equal to 5 wt %.

Alternatively, a polymer gelled electrolyte obtained in such a manner that a polymer is swelled with an electrolyte solution may be used.

When a polymer gel electrolyte is used, safety against liquid leakage and the like is improved. Furthermore, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP) can be used. The formed polymer may be porous.

Instead of the electrolyte solution, a solid electrolyte including an inorganic material such as a sulfide-based inorganic material or an oxide-based inorganic material, or a solid electrolyte including a high-molecular material such as a PEO (polyethylene oxide)-based high-molecular material may alternatively be used. When the solid electrolyte is used, a separator and a spacer are not necessary. Furthermore, the battery can be entirely solidified; therefore, there is no possibility of liquid leakage and thus the safety of the battery is dramatically increased.

### [Separator]

The secondary battery preferably includes a separator. As the separator, for example, paper; nonwoven fabric; glass fiber; ceramics; or synthetic fiber containing nylon (polyamide), vinylon (polyvinyl alcohol-based fiber), polyester, acrylic, polyolefin, or polyurethane can be used. The separator is preferably formed to have an envelope-like shape to wrap one of the positive electrode and the negative electrode.

The separator may have a multilayer structure. For example, an organic material film such as polypropylene or polyethylene can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

Deterioration of the separator in charge and discharge at high voltage can be inhibited and thus the reliability of the secondary battery can be improved because oxidation resistance is improved when the separator is coated with the ceramic-based material. In addition, when the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of the polypropylene film that is in contact with the positive electrode may be coated with the mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Exterior Body]

For an exterior body included in the secondary battery, a metal material such as aluminum or a resin material can be used, for example. An exterior body in the form of a film can also be used. As the film, for example, a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film can be used.

### Structure Example 2 of Secondary Battery

A structure of a secondary battery using a solid electrolyte is described below as a structure example of a secondary battery.

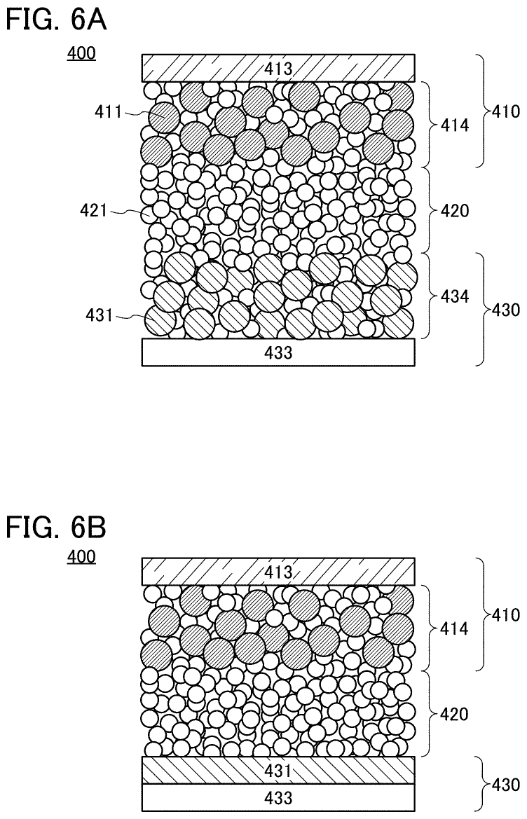

As shown in FIG. 6A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. As the positive electrode active material 411, the positive electrode active material 100 or a mixture of the positive electrode active material 100 and the positive electrode active material 200 described in the above embodiment can be used. The positive electrode active material layer 414 may also include a conductive additive and a binder.

The solid electrolyte layer 420 includes the solid electrolyte 421. The solid electrolyte layer 420 is positioned between the positive electrode 410 and the negative electrode 430, and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may also include a conductive additive and a binder. Note that when metallic lithium is used for the negative electrode 430, it is possible that the negative electrode 430 does not include the solid electrolyte 421 as shown in FIG. 6B. The use of metallic lithium for the negative electrode 430 is preferable because the energy density of the secondary battery 400 can be increased.

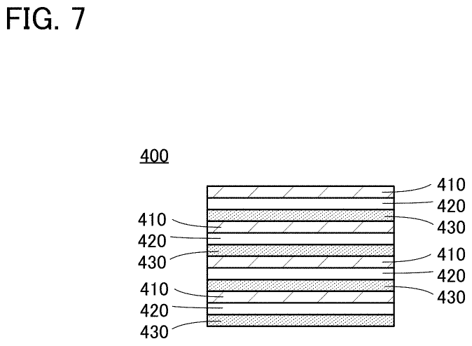

As shown in FIG. 7A, the secondary battery may have a structure in which a combination of the positive electrode 410, the solid electrolyte layer 420, and the negative electrode 430 is stacked. Stacking the positive electrodes 410, the solid electrolyte layers 420, and the negative electrodes 430 can increase the output voltage of the secondary battery. FIG. 7A is a schematic diagram illustrating the case where four layers of the combination of the positive electrode 410, the solid electrolyte layer 420, and the negative electrode 430 are stacked.

As materials for the solid electrolyte 421 and the solid electrolyte layer 420 included in the solid electrolyte layer 420, a sulfide-based solid electrolyte, an oxide-based solid electrolyte, or a halide-based solid electrolyte can be used, for example.

Examples of the sulfide-based solid electrolyte include a thio-silicon-based material (e.g., Li₁₀GeP₂S₁₂ and Li_{3.25}Ge_{0.25}P_{0.75}S₄), sulfide glass (e.g., 70Li₂S.30P₂S₅, 30Li₂S.26B₂S₃.44LiI, 63Li₂S.38SiS₂.1Li₃PO₄, 57Li₂S.38SiS₂.5Li₄SiO₄, and 50Li₂S.50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a conduction path after charge and discharge because of its relative softness.

Examples of the oxide-based solid electrolyte include a material with a perovskite crystal structure (e.g., La_{2/3-x}Li₃ₓTiO₃), a material with a NASICON crystal structure (e.g., Li_{1-X}Al_{X}Ti_{2-X}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄.50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃ (0<x<1) with a NASICON crystal structure (hereinafter LATP) is preferable because LATP contains aluminum, which is the element included in the positive electrode active material 100 of one embodiment of the present invention, and thus a synergistic effect of improving the cycle performance is expected. Moreover, higher productivity due to the reduction in the number of steps is expected. Note that in this specification and the like, a material with a NASICON crystal structure refers to a compound that is represented by M₂(XO₄)₃ (M: transition metal; X: S, P, As, Mo, W, or the like) and has a structure in which MO₆ octahedra and XO₄ tetrahedra that share common corners are arranged three-dimensionally.

This embodiment can be implemented in appropriate combination with the other embodiments.

### Embodiment 3

Described in this embodiment are examples of the shape of a secondary battery containing the positive electrode active material 100 or a mixture of the positive electrode active material 100 and the positive electrode active material 200 described in the above embodiment. For the materials used for the secondary battery described in this embodiment, the description of the above embodiment can be referred to.

### [Coin-Type Secondary Battery]

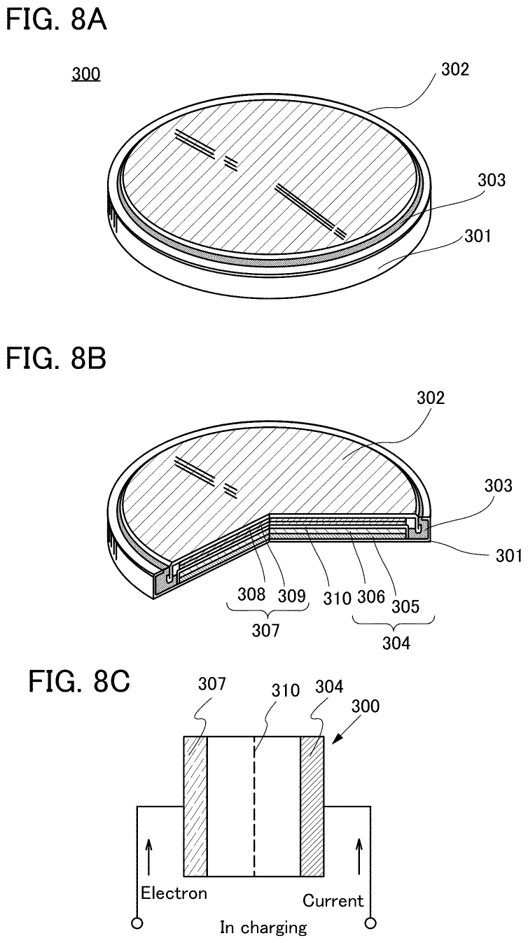

First, an example of a coin-type secondary battery is described. FIG. 8A is an external view of a coin-type (single-layer flat type) secondary battery, and FIG. 8B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. Alternatively, the positive electrode can 301 and the negative electrode can 302 are preferably covered with nickel, aluminum, or the like in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and a separator 310 are immersed in the electrolyte solution. Then, as shown in FIG. 8B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 located therebetween, whereby the coin-type secondary battery 300 is manufactured.

When the positive electrode active material described in the above embodiment is used in the positive electrode 304, the coin-type secondary battery 300 with high capacity and excellent cycle performance can be obtained.

Here, a current flow in charging a secondary battery is described with reference to FIG. 8C. When a secondary battery using lithium is regarded as a closed circuit, lithium ions transfer and a current flows in the same direction. Note that in the secondary battery using lithium, an anode and a cathode change places in charge and discharge, and an oxidation reaction and a reduction reaction occur on the corresponding sides; hence, an electrode with a high reaction potential is called a positive electrode and an electrode with a low reaction potential is called a negative electrode. For this reason, in this specification, the positive electrode is referred to as a “positive electrode” or a “plus electrode” and the negative electrode is referred to as a “negative electrode” or a “minus electrode” in all the cases where charge is performed, discharge is performed, a reverse pulse current is supplied, and a charge current is supplied. The use of the terms “anode” and “cathode” related to an oxidation reaction and a reduction reaction might cause confusion because the anode and the cathode change places at the time of charge and discharge. Thus, the terms “anode” and “cathode” are not used in this specification. If the term “anode” or “cathode” is used, it should be mentioned that the anode or the cathode is which of the one at the time of charge or the one at the time of discharge and corresponds to which of a positive (plus) electrode or a negative (minus) electrode.

Two terminals shown in FIG. 8C are connected to a charger, and the secondary battery 300 is charged. As the charge of the secondary battery 300 proceeds, a potential difference between electrodes increases.

### [Cylindrical Secondary Battery]

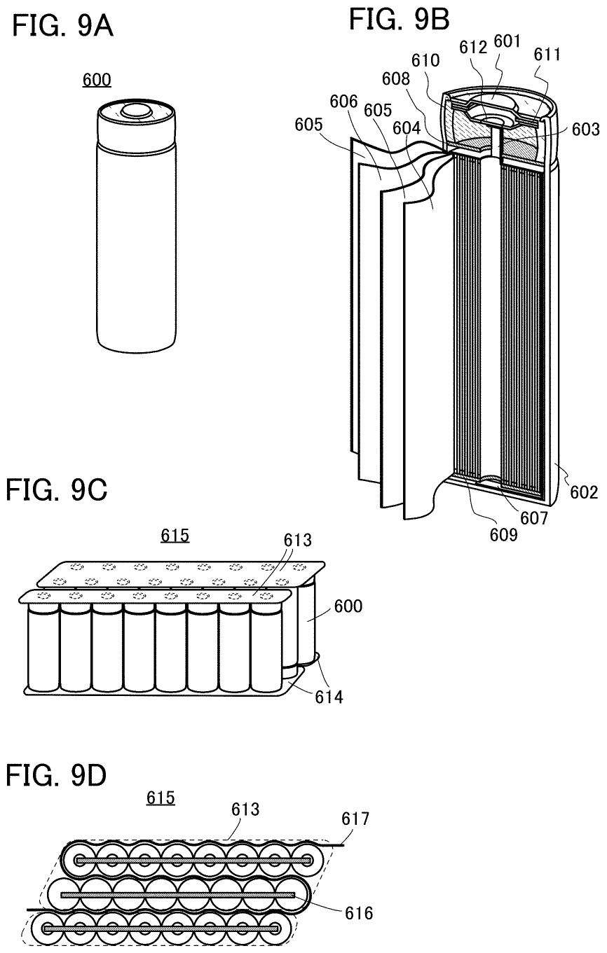

Next, an example of a cylindrical secondary battery is described with reference to FIG. 9. FIG. 9A shows an external view of a cylindrical secondary battery 600. FIG. 9B is a schematic cross-sectional view of the cylindrical secondary battery 600. The cylindrical secondary battery 600 includes, as shown in FIG. 9B, a positive electrode cap (battery lid) 601 on the top surface and a battery can (outer can) 602 on a side surface and a bottom surface. The positive electrode cap and the battery can (outer can) 602 are insulated from each other by a gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. Although not shown, the battery element is wound around a center pin. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. Alternatively, the battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, a nonaqueous electrolyte solution (not shown) is injected inside the battery can 602 provided with the battery element. As the nonaqueous electrolyte solution, a nonaqueous electrolyte solution that is similar to that of the coin-type secondary battery can be used.

Since the positive electrode and the negative electrode of the cylindrical storage battery are wound, active materials are preferably formed on both sides of the current collectors. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. The PTC element 611, which serves as a thermally sensitive resistor whose resistance increases as temperature rises, limits the amount of current by increasing the resistance, in order to prevent abnormal heat generation. Barium titanate (BaTiO₃)-based semiconductor ceramic can be used for the PTC element.

Alternatively, as shown in FIG. 9C, a plurality of secondary batteries 600 may be provided between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 9D is a top view of the module 615. The conductive plate 613 is shown by a dotted line for clarity of the drawing. As shown in FIG. 9D, the module 615 may include a wiring 616 electrically connecting the plurality of secondary batteries 600 with each other. It is possible to provide the conductive plate over the wiring 616 to overlap with each other. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is less likely to be influenced by the outside temperature. A heating medium included in the temperature control device 617 preferably has an insulating property and incombustibility.

When the positive electrode active material described in the above embodiment is used in the positive electrode 604, the cylindrical secondary battery 600 with high capacity and excellent cycle performance can be obtained.

### Structure Examples of Secondary Battery

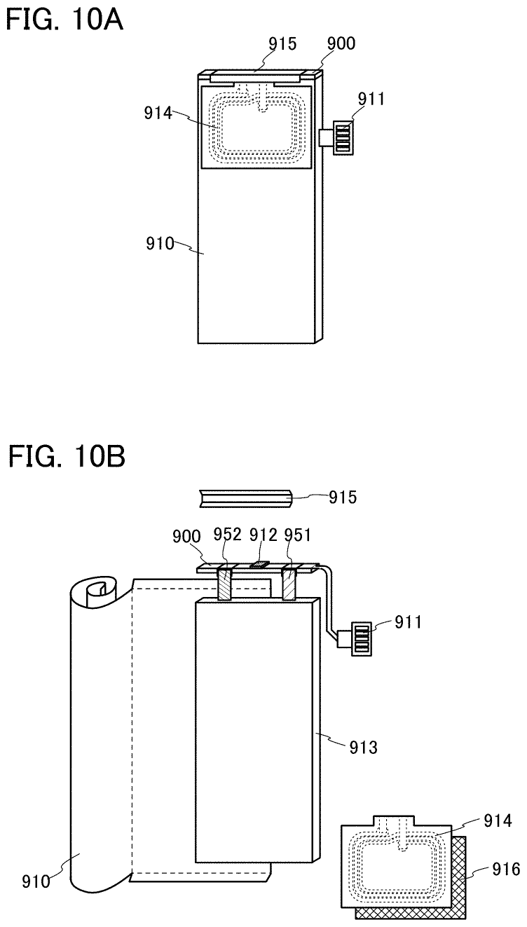

Other structure examples of secondary batteries are described with reference to FIG. 10 to FIG. 13.

FIG. 10A and FIG. 10B are external views of a secondary battery. A secondary battery 913 is connected to an antenna 914 and an antenna 915 through a circuit board 900. A label 910 is attached to the secondary battery 913. In addition, as shown in FIG. 10B, the secondary battery 913 is connected to a terminal 951 and a terminal 952.

The circuit board 900 includes a terminal 911 and a circuit 912. The terminal 911 is connected to the terminal 951, the terminal 952, the antenna 914, the antenna 915, and the circuit 912. Note that a plurality of terminals 911 may be provided and each of the plurality of terminals 911 may serve as a control signal input terminal, a power supply terminal, and the like.

The circuit 912 may be provided on the rear surface of the circuit board 900. Note that the shapes of the antenna 914 and the antenna 915 are not limited to coil shapes, and may be linear shapes or plate shapes, for example. An antenna such as a planar antenna, an aperture antenna, a traveling-wave antenna, an EH antenna, a magnetic-field antenna, or a dielectric antenna may be used. Alternatively, the antenna 914 or the antenna 915 may be a flat-plate conductor. The flat-plate conductor can serve as one of conductors for electric field coupling. That is, the antenna 914 or the antenna 915 may serve as one of two conductors of a capacitor. Thus, electric power can be transmitted and received not only by an electromagnetic field or a magnetic field but also by an electric field.

The line width of the antenna 914 is preferably larger than the line width of the antenna 915. This makes it possible to increase the amount of power received by the antenna 914.

The secondary battery includes a layer 916 between the antenna 914 and the antenna 915, and the secondary battery 913. The layer 916 has a function of blocking an electromagnetic field from the secondary battery 913, for example. As the layer 916, for example, a magnetic body can be used.

Note that the structure of the secondary battery is not limited to that in FIG. 10.

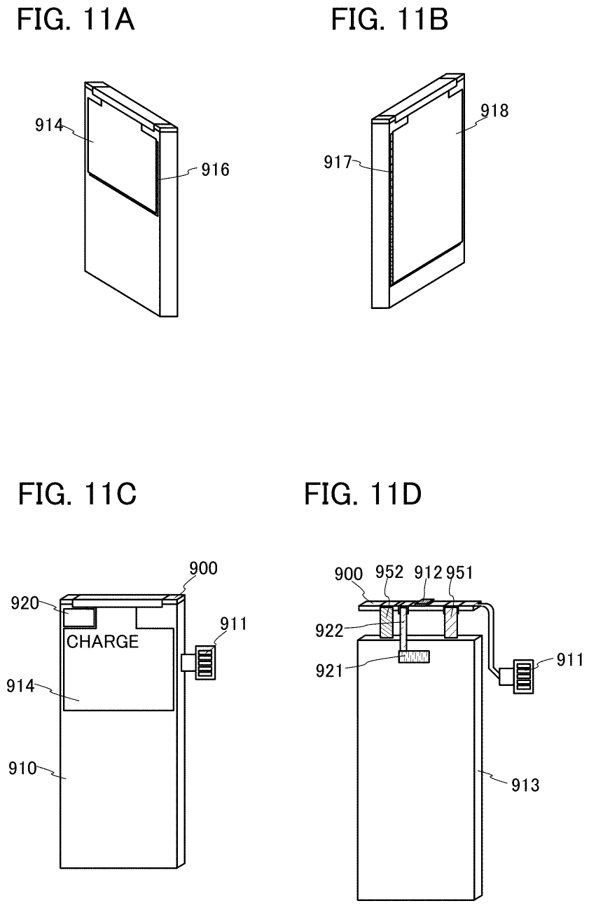

For example, as shown in FIG. 11A and FIG. 11B, opposing surfaces of the secondary battery 913 in FIG. 10A and FIG. 10B may be provided with respective antennas. FIG. 11A is an external view seen from one side of the opposing surfaces, and FIG. 11B is an external view seen from the other side of the opposing surfaces. For portions similar to those in FIG. 10A and FIG. 10B, refer to the description of the secondary battery shown in FIG. 10A and FIG. 10B as appropriate.

As shown in FIG. 11A, the antenna 914 is provided on one of the opposing surfaces of the secondary battery 913 with the layer 916 located therebetween, and as shown in FIG. 11B, an antenna 918 is provided on the other of the opposing surfaces of the secondary battery 913 with a layer 917 located therebetween. The layer 917 has a function of blocking an electromagnetic field from the secondary battery 913, for example. As the layer 917, for example, a magnetic body can be used.

With the above structure, both of the antenna 914 and the antenna 918 can be increased in size. The antenna 918 has a function of communicating data with an external device, for example. An antenna with a shape that can be used for the antenna 914, for example, can be used as the antenna 918. As a system for communication using the antenna 918 between the secondary battery and another device, a response method that can be used between the secondary battery and another device, such as NFC (near field communication), can be employed.

Alternatively, as shown in FIG. 11C, the secondary battery 913 in FIG. 10A and FIG. 10B may be provided with a display device 920. The display device 920 is electrically connected to the terminal 911. Note that the label 910 is not necessarily provided in a portion where the display device 920 is provided. For portions similar to those of the secondary battery shown in FIG. 10A and FIG. 10B, the description of the secondary battery shown in FIG. 10A and FIG. 10B can be referred to as appropriate.

The display device 920 may display, for example, an image showing whether charge is being carried out, an image showing the amount of stored power, or the like. As the display device 920, electronic paper, a liquid crystal display device, an electroluminescent (also referred to as EL) display device, or the like can be used. For example, the use of electronic paper can reduce the power consumption of the display device 920.

Alternatively, as shown in FIG. 11D, the secondary battery 913 shown in FIG. 10A and FIG. 10B may be provided with a sensor 921. The sensor 921 is electrically connected to the terminal 911 via a terminal 922. For portions similar to those of the secondary battery shown in FIG. 10A and FIG. 10B, the description of the secondary battery shown in FIG. 10A and FIG. 10B can be referred to as appropriate.

The sensor 921 has a function of measuring, for example, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays. With the sensor 921, for example, data on an environment (e.g., temperature) where the secondary battery is placed can be acquired and stored in a memory inside the circuit 912.

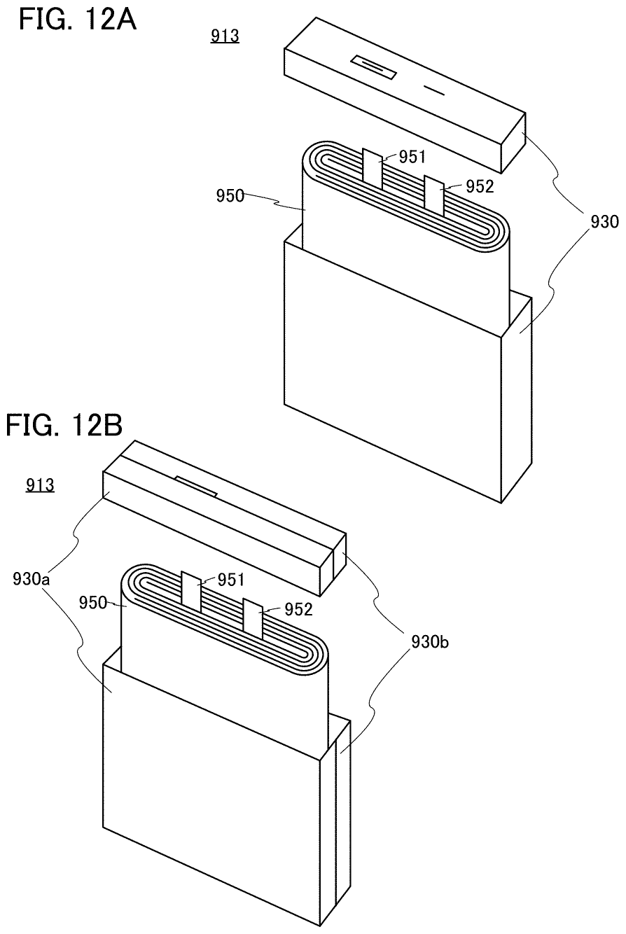

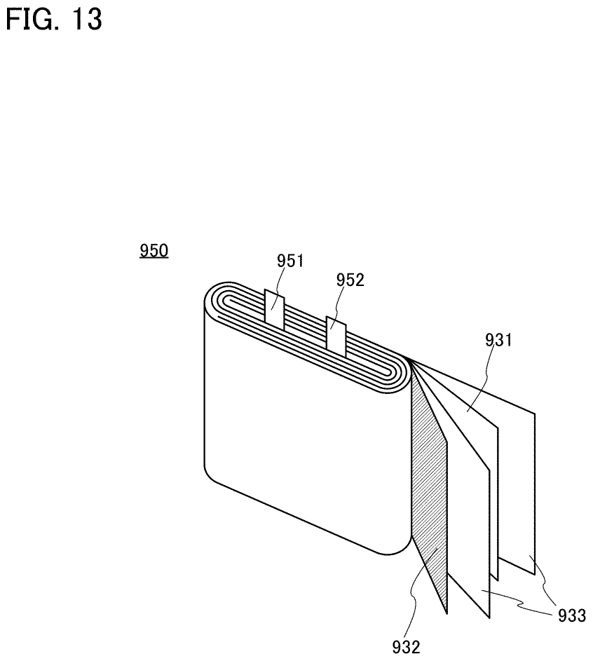

Furthermore, structure examples of the secondary battery 913 are described using FIG. 12 and FIG. 13.

The secondary battery 913 shown in FIG. 12A includes a wound body 950 provided with the terminal 951 and the terminal 952 inside a housing 930. The wound body 950 is immersed in an electrolyte solution inside the housing 930. The terminal 952 is in contact with the housing 930. An insulator or the like inhibits contact between the terminal 951 and the housing 930. Note that in FIG. 12A, the housing 930 divided into two pieces is shown for convenience; however, in the actual structure, the wound body 950 is covered with the housing 930 and the terminal 951 and the terminal 952 extend to the outside of the housing 930. For the housing 930, a metal material (e.g., aluminum) or a resin material can be used.

Note that as shown in FIG. 12B, the housing 930 shown in FIG. 12A may be formed using a plurality of materials. For example, in the secondary battery 913 shown in FIG. 12B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field from the secondary battery 913 can be inhibited. When an electric field is not significantly blocked by the housing 930a, an antenna such as the antenna 914 or the antenna 915 may be provided inside the housing 930a. For the housing 930b, a metal material can be used, for example.

FIG. 13 shows the structure of the wound body 950. The wound body 950 includes a negative electrode 931, a positive electrode 932, and separators 933. The wound body 950 is obtained by winding a sheet of a stack in which the negative electrode 931 overlaps with the positive electrode 932 with the separator 933 provided therebetween. Note that a plurality of stacks of the negative electrode 931, the positive electrode 932, and the separator 933 may be further overlaid.

The negative electrode 931 is connected to the terminal 911 shown in FIG. 10 via one of the terminal 951 and the terminal 952. The positive electrode 932 is connected to the terminal 911 shown in FIG. 10 via the other of the terminal 951 and the terminal 952.

When the positive electrode active material described in the above embodiment is used in the positive electrode 932, the secondary battery 913 with high capacity and excellent cycle performance can be obtained.

### [Laminated Secondary Battery]

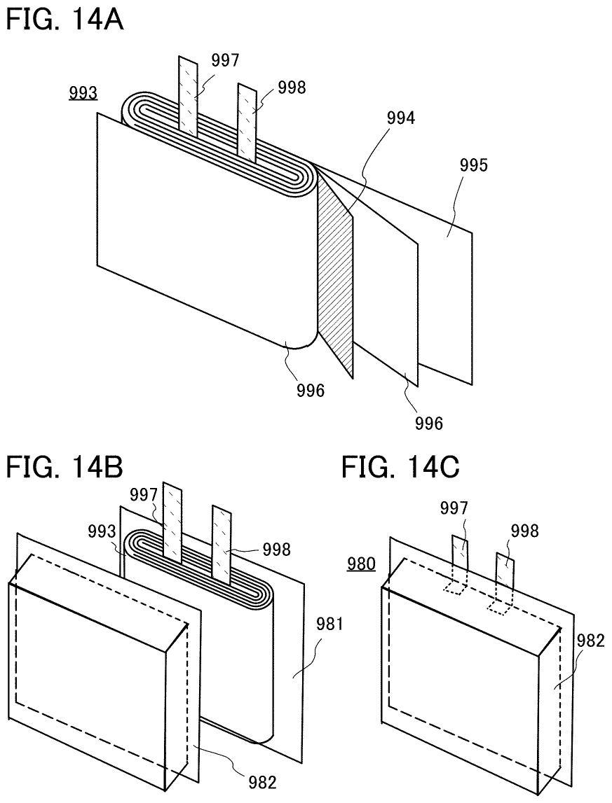

Next, an example of a laminated secondary battery is described with reference to FIG. 14 to FIG. 19. When the laminated secondary battery has flexibility and is used in an electronic device at least part of which is flexible, the secondary battery can be bent as the electronic device is bent.

A laminated secondary battery 980 is described with reference to FIG. 14. The laminated secondary battery 980 includes a wound body 993 shown in FIG. 14A. The wound body 993 includes a negative electrode 994, a positive electrode 995, and separators 996. The wound body 993 is, like the wound body 950 shown in FIG. 13, obtained by winding a sheet of a stack in which the negative electrode 994 overlaps with the positive electrode 995 with the separator 996 provided therebetween.

Note that the number of stacks each including the negative electrode 994, the positive electrode 995, and the separator 996 may be determined as appropriate depending on required capacity and element volume. The negative electrode 994 is connected to a negative electrode current collector (not shown) via one of a lead electrode 997 and a lead electrode 998. The positive electrode 995 is connected to a positive electrode current collector (not shown) via the other of the lead electrode 997 and the lead electrode 998.

As shown in FIG. 14B, the wound body 993 is packed in a space formed by bonding a film 981 and a film 982 having a depressed portion, which serve as exterior bodies, by thermocompression bonding or the like, whereby the secondary battery 980 shown in FIG. 14C can be fabricated. The wound body 993 includes the lead electrode 997 and the lead electrode 998, and is immersed in an electrolyte solution inside a space surrounded by the film 981 and the film 982 having a depressed portion.

For the film 981 and the film 982 having a depressed portion, a metal material such as aluminum or a resin material can be used, for example. With the use of a resin material for the film 981 and the film 982 having a depressed portion, the film 981 and the film 982 having a depressed portion can be changed in their forms when external force is applied; thus, a flexible storage battery can be fabricated.

FIG. 14B and FIG. 14C show an example of using two films; the wound body 993 may be placed in a space formed by bending one film.

When the positive electrode active material described in the above embodiment is used in the positive electrode 995, the secondary battery 980 with high capacity and excellent cycle performance can be obtained.

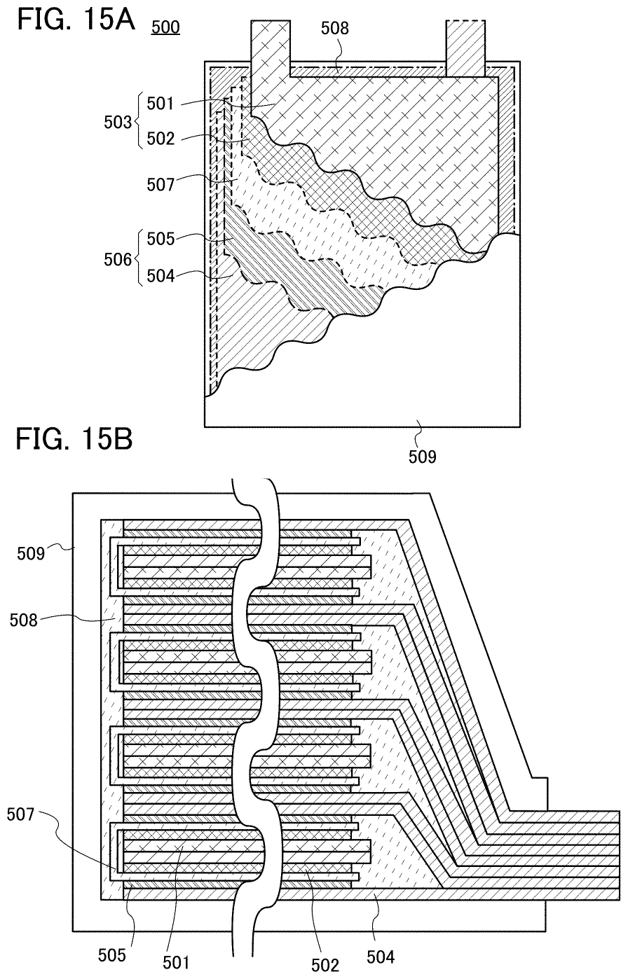

FIG. 14 shows an example of the secondary battery 980 that includes a wound body in a space formed by films serving as exterior bodies; alternatively, as shown in FIG. 15, a secondary battery may include a plurality of strip-shaped positive electrodes, separators, and negative electrodes in a space formed by films serving as exterior bodies, for example.

A laminated secondary battery 500 shown in FIG. 15A includes a positive electrode 503 including a positive electrode current collector 501 and a positive electrode active material layer 502, a negative electrode 506 including a negative electrode current collector 504 and a negative electrode active material layer 505, a separator 507, an electrolyte solution 508, and an exterior body 509. The separator 507 is provided between the positive electrode 503 and the negative electrode 506 in the exterior body 509. The exterior body 509 is filled with the electrolyte solution 508. The electrolyte solution described in Embodiment 2 can be used as the electrolyte solution 508.

In the laminated secondary battery 500 shown in FIG. 15A, the positive electrode current collector 501 and the negative electrode current collector 504 also serve as terminals for electrical contact with the outside. For this reason, the positive electrode current collector 501 and the negative electrode current collector 504 may be arranged so as to be partly exposed to the outside of the exterior body 509. Alternatively, a lead electrode and the positive electrode current collector 501 or the negative electrode current collector 504 may be bonded to each other by ultrasonic welding, and instead of the positive electrode current collector 501 and the negative electrode current collector 504, the lead electrode may be exposed to the outside of the exterior body 509.

As the exterior body 509 of the laminated secondary battery 500, for example, a laminate film having a three-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

FIG. 15B shows an example of a cross-sectional structure of the laminated secondary battery 500. FIG. 15A shows an example in which only two current collectors are included for simplicity; an actual battery includes a plurality of electrode layers as shown in FIG. 15B.

In FIG. 15B, the number of electrode layers is 16, for example. The secondary battery 500 has flexibility even though including 16 electrode layers. FIG. 15B shows a structure including 8 layers of negative electrode current collectors 504 and 8 layers of positive electrode current collectors 501, i.e., 16 layers in total. Note that FIG. 15B shows a cross section of the lead portion of the negative electrode, and the 8 layers of the negative electrode current collectors 504 are bonded to each other by ultrasonic welding. It is needless to say that the number of electrode layers is not limited to 16, and may be more than 16 or less than 16. With a large number of electrode layers, the secondary battery can have high capacity. In contrast, with a small number of electrode layers, the secondary battery can have small thickness and high flexibility.

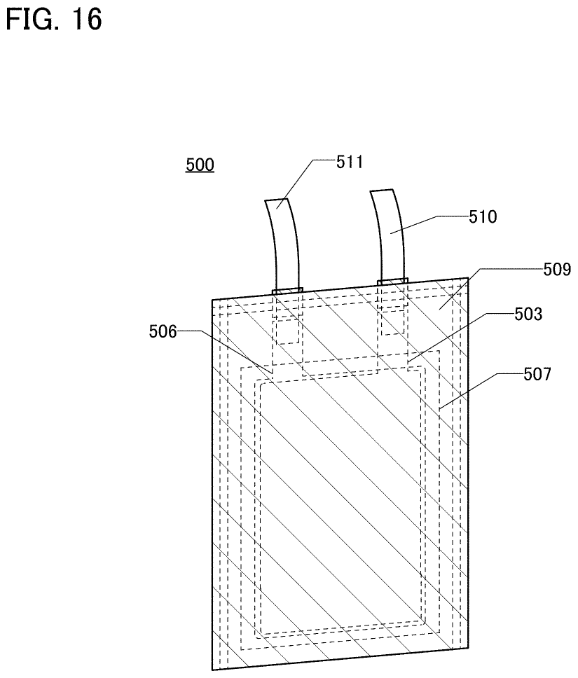

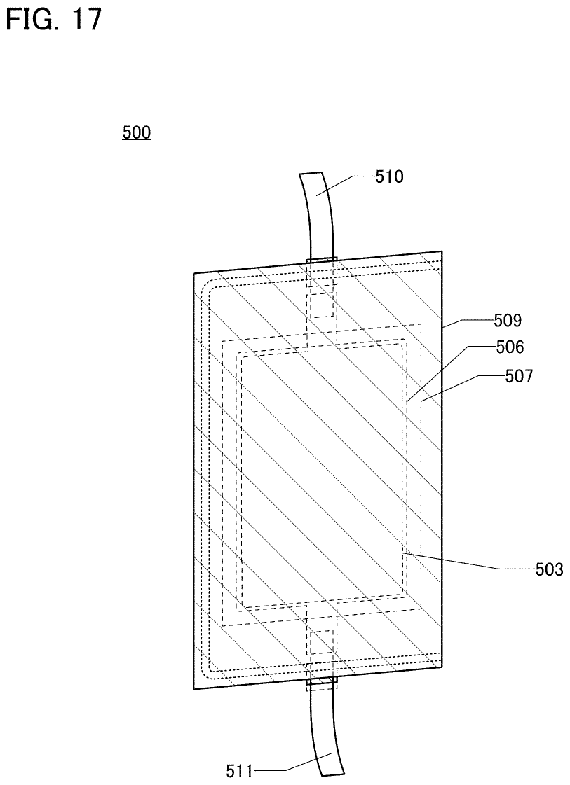

FIG. 16 and FIG. 17 each show an example of the external view of the laminated secondary battery 500. In FIG. 16 and FIG. 17, the laminated secondary battery 500 includes the positive electrode 503, the negative electrode 506, the separator 507, the exterior body 509, a positive electrode lead electrode 510, and a negative electrode lead electrode 511.

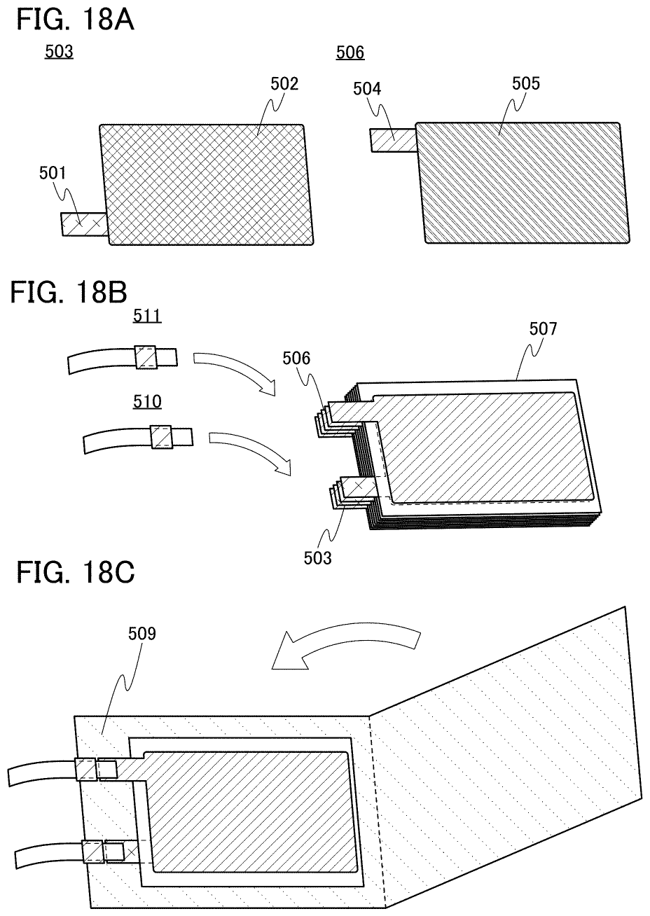

FIG. 18A shows external views of the positive electrode 503 and the negative electrode 506. The positive electrode 503 includes the positive electrode current collector 501, and the positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes the negative electrode current collector 504, and the negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to the examples shown in FIG. 18A.

### [Method for Manufacturing Laminated Secondary Battery]

Here, an example of a method for manufacturing the laminated secondary battery whose external view is shown in FIG. 16 is described with reference to FIG. 18B and FIG. 18C.

First, the negative electrode 506, the separator 507, and the positive electrode 503 are stacked. FIG. 18B shows a stack including the negative electrode 506, the separator 507, and the positive electrode 503. Shown here is an example using 5 negative electrodes and 4 positive electrodes. Next, the tab regions of the positive electrodes 503 are bonded to each other, and the tab region of the positive electrode on the outermost surface and the positive electrode lead electrode 510 are bonded to each other. The bonding can be performed by ultrasonic welding, for example. In a similar manner, the tab regions of the negative electrodes 506 are bonded to each other, and the tab region of the negative electrode on the outermost surface and the negative electrode lead electrode 511 are bonded to each other.

After that, the negative electrode 506, the separator 507, and the positive electrode 503 are placed over the exterior body 509.

Subsequently, the exterior body 509 is folded along a dashed line as shown in FIG. 18C. Then, the outer edges of the exterior body 509 are bonded to each other. The bonding can be performed by thermocompression, for example. At this time, an unbonded region (hereinafter referred to as an inlet) is provided for part (or one side) of the exterior body 509 so that the electrolyte solution 508 can be introduced later.

Next, the electrolyte solution 508 (not shown) is introduced into the exterior body 509 from the inlet of the exterior body 509. The electrolyte solution 508 is preferably introduced in a reduced pressure atmosphere or in an inert gas atmosphere. Lastly, the inlet is sealed by bonding. In the above manner, the laminated secondary battery 500 can be fabricated.

When the positive electrode active material described in the above embodiment is used in the positive electrode 503, the secondary battery 500 with high capacity and excellent cycle performance can be obtained.

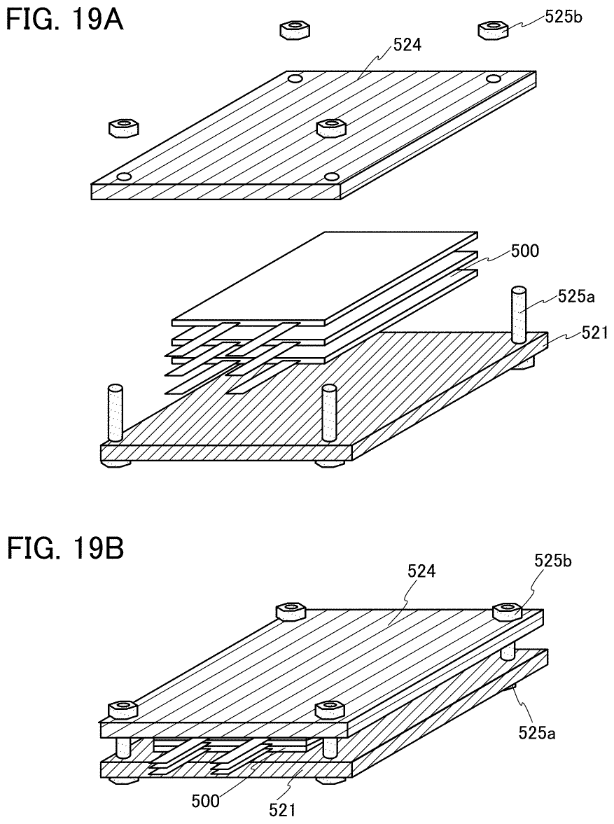

FIG. 19A is a perspective view showing three laminated secondary batteries 500 sandwiched and fixed between a first plate 521 and a second plate 524. The distance between the first plate 521 and the second plate 524 is fixed using a fixation tool 525a and a fixation tool 525b as shown in FIG. 19B, whereby pressure can be applied to the three secondary batteries 500.

Although FIG. 19A and FIG. 19B show an example of using the three laminated secondary batteries 500, the number of secondary batteries 500 is not particularly limited and four or more secondary batteries 500 can be used. A set of ten or more secondary batteries 500 can be used as a power source for a compact vehicle, and a set of 100 or more secondary batteries 500 can be used as an in-vehicle large power source. In order to prevent overcharge, the laminated secondary battery 500 may be provided with a protection circuit or a temperature sensor for monitoring the temperature rise.

[Exterior Body and Shape of all-Solid-State Battery]

An exterior body of a secondary battery including a solid electrolyte can be formed using a variety of materials and have a variety of shapes, and preferably has a function of applying pressure to a positive electrode, a solid electrolyte layer, and a negative electrode.

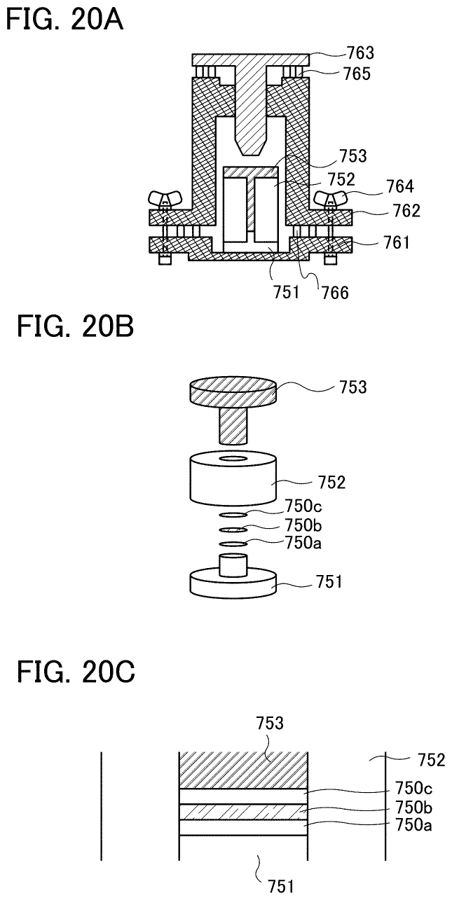

FIG. 20 shows an example of a cell for evaluating materials of an all-solid-state battery, for example.

FIG. 20A is a schematic cross-sectional view of an evaluation cell, the evaluation cell includes a lower component 761, an upper component 762, an insulator 766 for electrically isolating the lower component 761 and the upper component 762, and a fixation screw and a butterfly nut 764 for fixing them, and by rotating a pressure screw 763, an electrode plate 753 is pressed to fix an evaluation material. The insulator 766 is provided between the lower component 761 and the upper component 762 that are made of a stainless steel material. An 0 ring 765 for hermetic sealing is provided between the upper component 762 and the pressure screw 763.

The evaluation material is placed on an electrode plate 751, surrounded by an insulating tube 752, and pressed from above by the electrode plate 753. FIG. 20B is an enlarged perspective view of the evaluation material and its vicinity.

A stack of a positive electrode 750a, a solid electrolyte layer 750b, and a negative electrode 750c is shown as an example of the evaluation material, and its cross section is shown in FIG. 20C. Note that the same portions in FIG. 20A, FIG. 20B, and FIG. 20C are denoted by the same reference numerals.

The electrode plate 751 and the lower component 761 that are electrically connected to the positive electrode 750a can be said to correspond to a positive electrode terminal. The electrode plate 753 and the upper component 762 that are electrically connected to the negative electrode 750c can be said to correspond to a negative electrode terminal. The electric resistance or the like can be measured while pressure is applied to the evaluation material through the electrode plate 751 and the electrode plate 753.

The exterior body of the secondary battery of one embodiment of the present invention is preferably a package having excellent airtightness. For example, a ceramic package or a resin package can be used. Sealing of the exterior body is preferably performed in a closed atmosphere, for example, in a glove box, in which air is blocked.

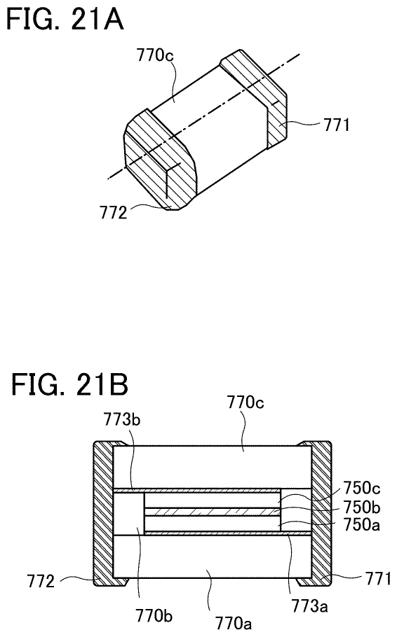

FIG. 21A is a perspective view of a secondary battery of one embodiment of the present invention that has an exterior body and a shape different from those in FIG. 20. The secondary battery in FIG. 21A includes external electrodes 771 and 772 and is sealed with an exterior body including a plurality of package components.

FIG. 21B shows an example of a cross section along the dashed-dotted line in FIG. 21A. A stacked body including the positive electrode 750a, the solid electrolyte layer 750b, and the negative electrode 750c is surrounded and sealed by a package component 770a in which an electrode layer 773a is provided on a flat plate, a frame-like package component 770b, and a package component 770c in which an electrode layer 773b is provided on a flat plate. For the package components 770a, 770b, and 770c, an insulating material such as a resin material or ceramic can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

In an all-solid-state battery, the contact state of the inside interfaces can be kept favorable by applying a predetermined pressure in the direction of stacking positive electrodes and negative electrodes. By applying a predetermined pressure in the direction of stacking positive electrodes and negative electrodes, expansion in the stacking direction due to charge and discharge of the all-solid-state battery can be inhibited, improving the reliability of the all-solid-state battery.

This embodiment can be implemented in appropriate combination with the other embodiments.

### Embodiment 4

In this embodiment, examples of electronic devices each including the secondary battery of one embodiment of the present invention will be described.

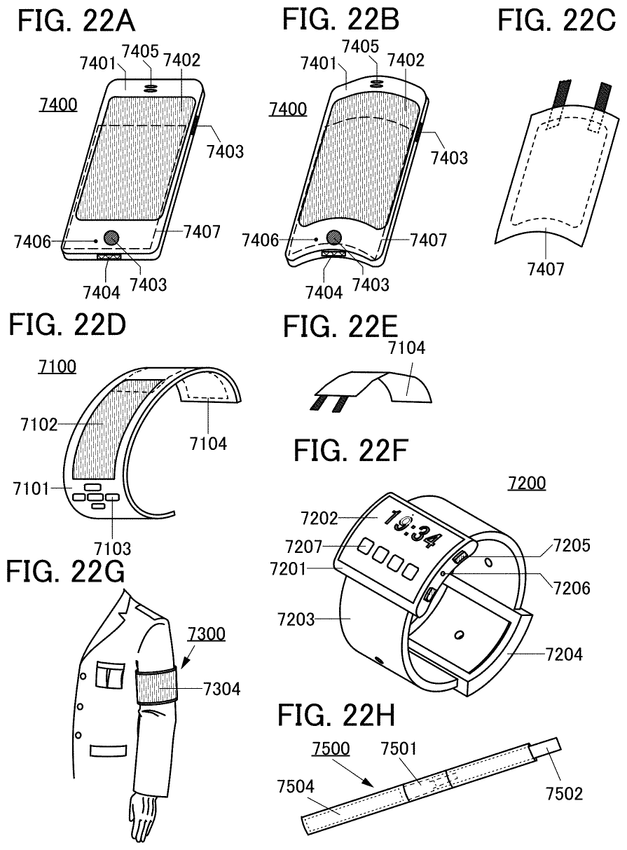

First, FIG. 22A to FIG. 22G show examples of electronic devices each including the secondary battery described in part of Embodiment 3. Examples of the electronic device including the secondary battery of one embodiment of the present invention include television sets (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines.

In addition, a flexible secondary battery can be incorporated along a curved surface of an inside wall or an outside wall of a house or a building or an interior or an exterior of an automobile.

FIG. 22A shows an example of a mobile phone. A mobile phone 7400 is provided with a display portion 7402 incorporated in a housing 7401, operation buttons 7403, an external connection port 7404, a speaker 7405, a microphone 7406, and the like. Note that the mobile phone 7400 includes a secondary battery 7407. When the secondary battery of one embodiment of the present invention is used as the secondary battery 7407, a lightweight mobile phone with a long lifetime can be provided.

FIG. 22B shows the mobile phone 7400 that is bent. When the whole mobile phone 7400 is bent by the external force, the secondary battery 7407 provided therein is also bent. FIG. 22C shows the bent secondary battery 7407. The secondary battery 7407 is a thin storage battery. The secondary battery 7407 is fixed in a state of being bent. Note that the secondary battery 7407 includes a lead electrode electrically connected to a current collector. The current collector is, for example, copper foil, and partly alloyed with gallium; thus, the adhesion between the current collector and an active material layer in contact with the current collector is improved and the secondary battery 7407 can have high reliability even in a state of being bent.

FIG. 22D shows an example of a bangle-type display device. A portable display device 7100 includes a housing 7101, a display portion 7102, operation buttons 7103, and a secondary battery 7104. FIG. 22E shows the bent secondary battery 7104. When the display device is worn on a user's arm while the secondary battery 7104 is bent, the housing changes its shape and the curvature of part or the whole of the secondary battery 7104 is changed. Note that a value represented by the radius of a circle that corresponds to the bending condition of a curve at a given point is referred to as the radius of curvature, and the reciprocal of the radius of curvature is referred to as curvature. Specifically, part or the whole of the housing or the main surface of the secondary battery 7104 is changed with a radius of curvature in the range of 40 mm to 150 mm. When the radius of curvature at the main surface of the secondary battery 7104 is within the range of 40 mm to 150 mm, the reliability can be kept high. When the secondary battery of one embodiment of the present invention is used as the secondary battery 7104, a lightweight portable display device with a long lifetime can be provided.

FIG. 22F shows an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by setting the operation system incorporated in the portable information terminal 7200.

The portable information terminal 7200 can employ near field wireless communication based on an existing communication standard. For example, mutual communication with a headset capable of wireless communication enables hands-free calling.

The portable information terminal 7200 includes the input/output terminal 7206, and data can be directly transmitted to and received from another information terminal via a connector. In addition, charge via the input/output terminal 7206 is possible. Note that the charge operation may be performed by wireless power feeding without using the input/output terminal 7206.

The display portion 7202 of the portable information terminal 7200 includes the secondary battery of one embodiment of the present invention. When the secondary battery of one embodiment of the present invention is used, a lightweight portable information terminal with a long lifetime can be provided. For example, the secondary battery 7104 shown in FIG. 22E can be provided in the housing 7201 while being curved, or can be provided in the band 7203 such that it can be curved.

The portable information terminal 7200 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 22G shows an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field wireless communication based on an existing communication standard.

The display device 7300 includes an input/output terminal, and data can be directly transmitted to and received from another information terminal via a connector. In addition, charge via the input/output terminal is possible. Note that the charge operation may be performed by wireless power feeding without using the input/output terminal.

When the secondary battery of one embodiment of the present invention is used as the secondary battery included in the display device 7300, a lightweight display device with a long lifetime can be provided.

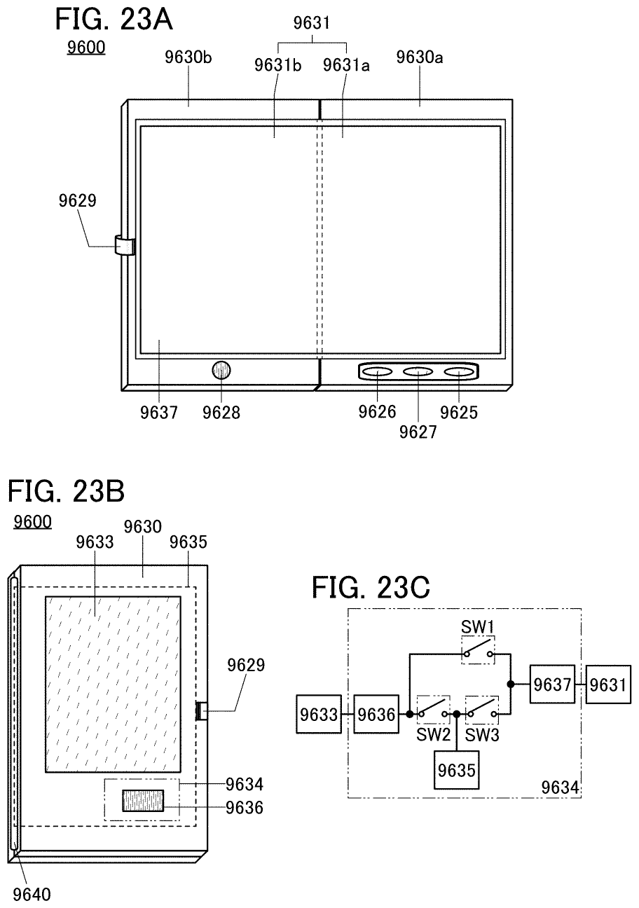

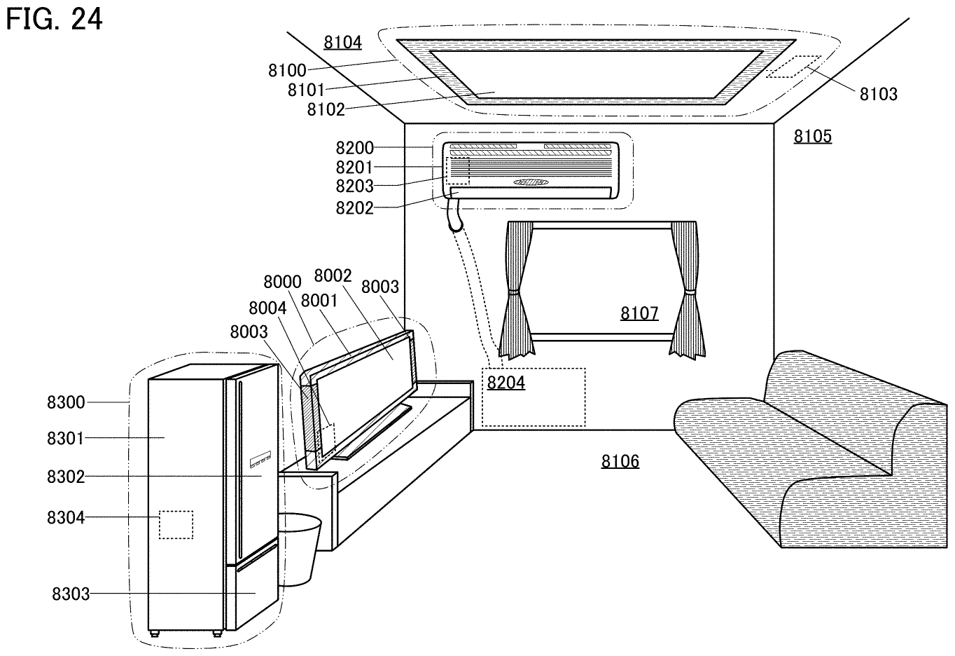

Examples of electronic devices each including the secondary battery with excellent cycle performance described in the above embodiment are described with reference to FIG. 22H, FIG. 23, and FIG. 24.

When the secondary battery of one embodiment of the present invention is used as a secondary battery of a daily electronic device, a lightweight product with a long lifetime can be provided. Examples of the daily electronic device include an electric toothbrush, an electric shaver, and electric beauty equipment. As secondary batteries of these products, small and lightweight stick type secondary batteries with high capacity are desired in consideration of handling ease for users.

FIG. 22H is a perspective view of a device called a cigarette smoking device (electronic cigarette). In FIG. 22H, an electronic cigarette 7500 includes an atomizer 7501 including a heating element, a secondary battery 7504 that supplies power to the atomizer, and a cartridge 7502 including a liquid supply bottle, a sensor, and the like. To improve safety, a protection circuit that prevents overcharge and overdischarge of the secondary battery 7504 may be electrically connected to the secondary battery 7504. The secondary battery 7504 shown in FIG. 22H includes an external terminal for connection to a charger. The electronic cigarette 7500 is held with the secondary battery 7504 being a tip portion; thus, it is desirable that the secondary battery 7504 have a short total length and be lightweight. With the secondary battery of one embodiment of the present invention, which has high capacity and excellent cycle performance, the small and lightweight electronic cigarette 7500 that can be used for a long time over a long period can be provided.

Next, FIG. 23A and FIG. 23B show an example of a tablet terminal that can be folded in half. A tablet terminal 9600 shown in FIG. 23A and FIG. 23B includes a housing 9630a, a housing 9630b, a movable portion 9640 connecting the housing 9630a and the housing 9630b to each other, a display portion 9631 including a display portion 9631a and a display portion 9631b, a switch 9625 to a switch 9627, a fastener 9629, and an operation switch 9628. A flexible panel is used for the display portion 9631, whereby a tablet terminal with a larger display portion can be provided. FIG. 23A shows the tablet terminal 9600 that is opened, and FIG. 23B shows the tablet terminal 9600 that is closed.

The tablet terminal 9600 includes a power storage unit 9635 inside the housing 9630a and the housing 9630b. The power storage unit 9635 is provided across the housing 9630a and the housing 9630b, passing through the movable portion 9640.

Part of or the entire display portion 9631 can be a touch panel region, and data can be input by touching text, an input form, an image including an icon, and the like displayed on the region. For example, it is possible that keyboard buttons are displayed on the entire display portion 9631a on the housing 9630a side, and data such as text or an image is displayed on the display portion 9631b on the housing 9630b side.

It is also possible that a keyboard is displayed on the display portion 9631b on the housing 9630b side, and data such as text or an image is displayed on the display portion 9631a on the housing 9630a side. Furthermore, it is possible that a switching button for showing/hiding a keyboard on a touch panel is displayed on the display portion 9631 and the button is touched with a finger, a stylus, or the like to display keyboard buttons on the display portion 9631.

Touch input can be performed concurrently in a touch panel region in the display portion 9631a on the housing 9630a side and a touch panel region in the display portion 9631b on the housing 9630b side.

The switch 9625 to the switch 9627 may function not only as an interface for operating the tablet terminal 9600 but also as an interface that can switch various functions. For example, at least one of the switch 9625 to the switch 9627 may have a function of switching on/off of the tablet terminal 9600. For another example, at least one of the switch 9625 to the switch 9627 may have a function of switching display between a portrait mode and a landscape mode and a function of switching display between monochrome display and color display. For another example, at least one of the switch 9625 to the switch 9627 may have a function of adjusting the luminance of the display portion 9631. The luminance of the display portion 9631 can be optimized in accordance with the amount of external light in use, which is detected by an optical sensor incorporated in the tablet terminal 9600. Note that another sensing device including a sensor for measuring inclination, such as a gyroscope sensor or an acceleration sensor, may be incorporated in the tablet terminal, in addition to the optical sensor.

FIG. 23A shows an example in which the display portion 9631a on the housing 9630a side and the display portion 9631b on the housing 9630b side have substantially the same display area; however, there is no particular limitation on the display areas of the display portion 9631a and the display portion 9631b, and the display portions may have different areas or different display quality. For example, one of the display panels may display higher definition images than the other.

The tablet terminal 9600 is folded in half in FIG. 23B. The tablet terminal 9600 includes a housing 9630, a solar cell 9633, and a charge and discharge control circuit 9634 including a DCDC converter 9636. The power storage unit of one embodiment of the present invention is used as the power storage unit 9635.

As described above, the tablet terminal 9600 can be folded in half, and thus can be folded when not in use such that the housing 9630a and the housing 9630b overlap with each other. Thus, the display portion 9631 can be protected owing to the folding, which increases the durability of the tablet terminal 9600. With the power storage unit 9635 including the secondary battery of one embodiment of the present invention, which has high capacity and excellent cycle performance, the tablet terminal 9600 that can be used for a long time over a long period can be provided.

The tablet terminal 9600 shown in FIG. 23A and FIG. 23B can also have a function of displaying various kinds of data (e.g., a still image, a moving image, and a text image), a function of displaying a calendar, a date, or the time on the display portion, a touch-input function of operating or editing data displayed on the display portion by touch input, a function of controlling processing by various kinds of software (programs), and the like.

The solar cell 9633, which is attached on the surface of the tablet terminal 9600, supplies electric power to a touch panel, a display portion, a video signal processing portion, and the like. Note that the solar cell 9633 can be provided on one surface or both surfaces of the housing 9630 and the power storage unit 9635 can be charged efficiently. The use of a lithium-ion battery as the power storage unit 9635 brings an advantage such as a reduction in size.

The structure and operation of the charge and discharge control circuit 9634 shown in FIG. 23B are described with reference to a block diagram in FIG. 23C. FIG. 23C shows the solar cell 9633, the power storage unit 9635, the DCDC converter 9636, a converter 9637, switches SW1 to SW3, and the display portion 9631, and the power storage unit 9635, the DCDC converter 9636, the converter 9637, and the switches SW1 to SW3 correspond to the charge and discharge control circuit 9634 shown in FIG. 23B.

First, an operation example in which electric power is generated by the solar cell 9633 using external light is described. The voltage of electric power generated by the solar cell is raised or lowered by the DCDC converter 9636 to a voltage for charging the power storage unit 9635. When the display portion 9631 is operated with the electric power from the solar cell 9633, the switch SW1 is turned on and the voltage is raised or lowered by the converter 9637 to a voltage needed for the display portion 9631. When display on the display portion 9631 is not performed, the switch SW1 is turned off and the switch SW2 is turned on, so that the power storage unit 9635 is charged.

Although the solar cell 9633 is described as an example of a power generation unit, one embodiment of the present invention is not limited to this example. The power storage unit 9635 may be charged using another power generation unit such as a piezoelectric element or a thermoelectric conversion element (Peltier element). For example, the charge may be performed with a non-contact power transmission module that performs charge by transmitting and receiving power wirelessly (without contact), or with a combination of other charge units.

FIG. 24 shows other examples of electronic devices. In FIG. 24, a display device 8000 is an example of an electronic device including a secondary battery 8004 of one embodiment of the present invention. Specifically, the display device 8000 corresponds to a display device for TV broadcast reception and includes a housing 8001, a display portion 8002, speaker portions 8003, the secondary battery 8004, and the like. The secondary battery 8004 of one embodiment of the present invention is provided in the housing 8001. The display device 8000 can receive electric power from a commercial power supply and can use electric power stored in the secondary battery 8004. Thus, the display device 8000 can be operated with the use of the secondary battery 8004 of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a DMD (Digital Micromirror Device), a PDP (Plasma Display Panel), or an FED (Field Emission Display) can be used for the display portion 8002.

Note that the display device includes, in its category, all of information display devices for personal computers, advertisement displays, and the like besides TV broadcast reception.

In FIG. 24, an installation lighting device 8100 is an example of an electronic device including a secondary battery 8103 of one embodiment of the present invention. Specifically, the lighting device 8100 includes a housing 8101, a light source 8102, the secondary battery 8103, and the like. Although FIG. 24 shows as an example the case where the secondary battery 8103 is provided in a ceiling 8104 on which the housing 8101 and the light source 8102 are installed, the secondary battery 8103 may be provided in the housing 8101. The lighting device 8100 can receive electric power from a commercial power supply and can use electric power stored in the secondary battery 8103. Thus, the lighting device 8100 can be operated with the use of the secondary battery 8103 of one embodiment of the present invention as an uninterruptible power supply even when electric power cannot be supplied from a commercial power supply due to power failure or the like.

Although the installation lighting device 8100 provided in the ceiling 8104 is shown in FIG. 24 as an example, the secondary battery of one embodiment of the present invention can be used in an installation lighting device provided in, for example, a side wall 8105, a floor 8106, or a window 8107 other than the ceiling 8104, and can be used in a tabletop lighting device or the like.

As the light source 8102, an artificial light source that emits light artificially by using electric power can be used. Specifically, an incandescent lamp, a discharge lamp such as a fluorescent lamp, and light-emitting elements such as an LED and an organic EL element are given as examples of the artificial light source.

In FIG. 24, an air conditioner including an indoor unit 8200 and an outdoor unit 8204 is an example of an electronic device including a secondary battery 8203 of one embodiment of the present invention. Specifically, the indoor unit 8200 includes a housing 8201, an air outlet 8202, the secondary battery 8203, and the like. Although FIG. 24 shows as an example the case where the secondary battery 8203 is provided in the indoor unit 8200, the secondary battery 8203 may be provided in the outdoor unit 8204. Alternatively, the secondary batteries 8203 may be provided in both the indoor unit 8200 and the outdoor unit 8204. The air conditioner can receive electric power from a commercial power supply and can use electric power stored in the secondary battery 8203. Particularly in the case where the secondary batteries 8203 are provided in both the indoor unit 8200 and the outdoor unit 8204, the air conditioner can be operated with the use of the secondary battery 8203 of one embodiment of the present invention as an uninterruptible power supply even when electric power cannot be supplied from a commercial power supply due to power failure or the like.

Although the split-type air conditioner including the indoor unit and the outdoor unit is shown in FIG. 24 as an example, the secondary battery of one embodiment of the present invention can be used in an air conditioner in which the function of an indoor unit and the function of an outdoor unit are integrated in one housing.

In FIG. 24, an electric refrigerator-freezer 8300 is an example of an electronic device including a secondary battery 8304 of one embodiment of the present invention. Specifically, the electric refrigerator-freezer 8300 includes a housing 8301, a refrigerator door 8302, a freezer door 8303, the secondary battery 8304, and the like. The secondary battery 8304 is provided in the housing 8301 in FIG. 24. The electric refrigerator-freezer 8300 can receive electric power from a commercial power supply and can use electric power stored in the secondary battery 8304. Thus, the electric refrigerator-freezer 8300 can be operated with the use of the secondary battery 8304 of one embodiment of the present invention as an uninterruptible power supply even when electric power cannot be supplied from a commercial power supply due to power failure or the like.

Note that among the electronic devices described above, a high-frequency heating apparatus such as a microwave oven and an electronic device such as an electric rice cooker require high power in a short time. The tripping of a breaker of a commercial power supply in use of an electronic device can be prevented by using the secondary battery of one embodiment of the present invention as an auxiliary power supply for supplying electric power which cannot be supplied enough by a commercial power supply.

Electric power is stored in the secondary battery in a time period when electronic devices are not used, particularly when the proportion of the amount of actually used electric power to the total amount of electric power that can be supplied from a commercial power supply source (such a proportion is referred to as a usage rate of electric power) is low, whereby the usage rate of electric power can be reduced in a time period other than the above time period. For example, in the case of the electric refrigerator-freezer 8300, electric power is stored in the secondary battery 8304 in night time when the temperature is low and the refrigerator door 8302 and the freezer door 8303 are not opened or closed. On the other hand, in daytime when the temperature is high and the refrigerator door 8302 and the freezer door 8303 are opened and closed, the secondary battery 8304 is used as an auxiliary power supply; thus, the usage rate of electric power in daytime can be reduced.

According to one embodiment of the present invention, the secondary battery can have excellent cycle performance and improved reliability. Furthermore, according to one embodiment of the present invention, a secondary battery with high capacity can be obtained; thus, the secondary battery itself can be made more compact and lightweight as a result of improved characteristics of the secondary battery. Thus, when the secondary battery of one embodiment of the present invention is used in the electronic device described in this embodiment, a more lightweight electronic device with a longer lifetime can be obtained.

This embodiment can be implemented in appropriate combination with the other embodiments.

### Embodiment 5

In this embodiment, examples of vehicles each including the secondary battery of one embodiment of the present invention will be described.

The use of secondary batteries in vehicles enables production of next-generation clean energy vehicles such as hybrid electric vehicles (HVs), electric vehicles (EVs), and plug-in hybrid electric vehicles (PHVs).

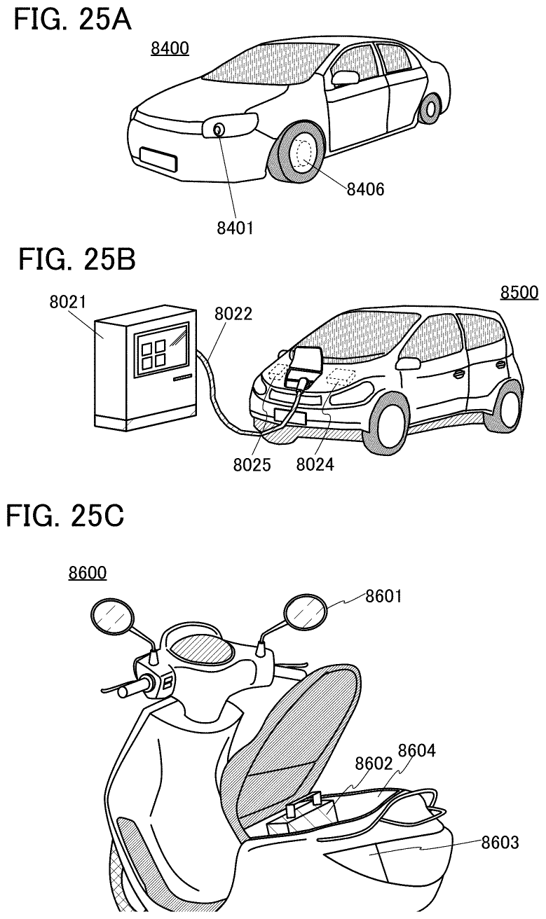

FIG. 25 shows examples of a vehicle including the secondary battery of one embodiment of the present invention. An automobile 8400 shown in FIG. 25A is an electric vehicle that runs on the power of an electric motor. Alternatively, the automobile 8400 is a hybrid electric vehicle capable of running on the power of either an electric motor or an engine as appropriate. The use of one embodiment of the present invention achieves a high-mileage vehicle. The automobile 8400 includes the secondary battery. As the secondary battery, the modules of the secondary batteries shown in FIG. 9C and FIG. 9D may be arranged to be used in a floor portion in the automobile. Alternatively, a battery pack in which a plurality of secondary batteries shown in FIG. 12 are combined may be placed in the floor portion in the automobile. The secondary battery is used not only for driving an electric motor 8406, but also for supplying electric power to a light-emitting device such as a headlight 8401 or a room light (not shown).

The secondary battery can also supply electric power to a display device included in the automobile 8400, such as a speedometer or a tachometer. Furthermore, the secondary battery can supply electric power to a semiconductor device included in the automobile 8400, such as a navigation system.

An automobile 8500 shown in FIG. 25B can be charged when the secondary battery included in the automobile 8500 is supplied with electric power through external charge equipment by a plug-in system, a contactless power feeding system, or the like. FIG. 25B shows a state where a secondary battery 8024 included in the automobile 8500 is charged with the use of a ground-based charging apparatus 8021 through a cable 8022. Charging can be performed as appropriate by a given method such as CHAdeMO (registered trademark) or Combined Charging System as a charging method, the standard of a connector, or the like. The charging apparatus 8021 may be a charge station provided in a commerce facility or a power source in a house. For example, with the use of a plug-in technique, the secondary battery 8024 included in the automobile 8500 can be charged by being supplied with electric power from outside. The charging can be performed by converting AC electric power into DC electric power through a converter such as an ACDC converter.

Although not shown, the vehicle may include a power receiving device so that it can be charged by being supplied with electric power from an above-ground power transmitting device in a contactless manner. In the case of the contactless power feeding system, by fitting a power transmitting device in a road or an exterior wall, charging can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 25C shows an example of a motorcycle including the secondary battery of one embodiment of the present invention. A motor scooter 8600 shown in FIG. 25C includes a secondary battery 8602, side mirrors 8601, and direction indicators 8603. The secondary battery 8602 can supply electric power to the direction indicators 8603.

In the motor scooter 8600 shown in FIG. 25C, the secondary battery 8602 can be held in a storage unit under seat 8604. The secondary battery 8602 can be held in the storage unit under seat 8604 even when the storage unit under seat 8604 is small. The secondary battery 8602 is detachable; thus, the secondary battery 8602 is carried indoors when charged, and is stored before the motor scooter is driven.

According to one embodiment of the present invention, the secondary battery can have improved cycle performance and the capacity of the secondary battery can be increased. Thus, the secondary battery itself can be made more compact and lightweight. The compact and lightweight secondary battery contributes to a reduction in the weight of a vehicle, and thus increases the mileage. Furthermore, the secondary battery included in the vehicle can be used as a power source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals typified by cobalt can be reduced.

This embodiment can be implemented in appropriate combination with the other embodiments.

### Example 1

In this example, a positive electrode active material of one embodiment of the present invention was formed and the particle size distribution and powder packing density (PPD) were evaluated.

First, a positive electrode active material with a small particle diameter was formed by the forming method of the positive electrode active material 100 shown in Embodiment 1 and FIG. 4.

First, lithium carbonate and tetracobalt trioxide were prepared as a lithium source and a cobalt source, respectively (Step S11); crushing and mixing were performed in a ball mill at 200 rpm for 12 hours (Step S12); and baking was performed at 950° C. for 10 hours (Step S13), whereby lithium cobalt oxide was obtained (Step S14).

Next, nickel hydroxide was prepared as a nickel source (Step S21). Aluminum hydroxide was prepared as an aluminum source (Step S22).

Magnesium fluoride (MGH18XB, Kojundo Chemical Laboratory Co., Ltd.) was prepared as a magnesium source and a fluorine source and lithium fluoride (LIH10XB, Kojundo Chemical Laboratory Co., Ltd.) was prepared as a fluorine source (Step S31). Weighing was performed so as to satisfy LiF:MgF₂=1:3 (molar ratio), and crushing and mixing were performed in a ball mill (Step S32), whereby the mixture 902 was obtained (Step S33). A median diameter D₅₀ of approximately 3.5 μm was obtained when the particle size distribution of the mixture 902 was measured by a laser diffraction and scattering method.

Then, lithium cobalt oxide, nickel hydroxide, aluminum hydroxide, and the mixture 902 formed above were mixed in a ball mill (Step S41) to give the mixture 903 (Step S42). The mixture ratio was set so that when the number of cobalt atoms was taken as 100, the number of nickel atoms was 0.5, the number of aluminum atoms was 0.5, and the number of magnesium atoms was 1.

The mixture 903 was annealed at 800° C. for 2 hours in an oxygen atmosphere (Step S43) to give a composite oxide (Step S44). The composite oxide after the annealing and before crushing was used as a sample 99.

Then, the composite oxide was crushed with a thin-film spin system high-speed mixer (FILMIX Model 30-L, PRIMIX corporation) or a ball mill (Step S45). The crushed composite oxide was collected to give a positive electrode active material (Step S46). The positive electrode active material formed using the thin-film spin system high-speed mixer for crushing was used as a sample 100 and the positive electrode active material formed using the ball mill for crushing was used as a sample 101.

Next, a positive electrode active material with a large particle diameter was formed by the forming method of the positive electrode active material 200 shown in Embodiment 1 and FIG. 5.

Lithium cobalt oxide synthesized in advance (C-10N, NIPPON CHEMICAL INDUSTRIAL CO., LTD.) was prepared as lithium cobalt oxide (Step S14). Nickel hydroxide was prepared as a nickel source (Step S21), and aluminum hydroxide was prepared as an aluminum source (Step S22). The mixture 902 was formed in a manner similar to that in FIG. 4 (Steps S31 to S33).

Then, lithium cobalt oxide, nickel hydroxide, aluminum hydroxide, and the mixture 902 were mixed in a ball mill (Step S41) to give the mixture 903 (Step S42). The mixture ratio was set so that when the number of cobalt atoms was taken as 100, the number of nickel atoms was 0.5, the number of aluminum atoms was 0.5, and the number of magnesium atoms was 1.

The mixture 903 was heated at 850° C. for 10 hours in an oxygen atmosphere (Step S43) to give the positive electrode active material 200 (Step S44). The thus formed positive electrode active material was used as a sample 200.

Next, as a comparative example, a positive electrode active material with a small particle diameter that does not contain nickel, aluminum, magnesium, and fluorine was formed.

A lithium cobalt oxide particle (product name: CELLSEED C-5H) manufactured by NIPPON CHEMICAL INDUSTRIAL CO., LTD. was crushed in a ball mill at 200 rpm for 12 hours to be used as a sample 300. CELLSEED C-5H is lithium cobalt oxide in which in the impurity analysis by a glow discharge mass spectroscopy method (GD-MS), the magnesium concentration and the fluorine concentration are less than or equal to 50 ppm wt, the calcium concentration, the aluminum concentration, and the silicon concentration are less than or equal to 100 ppm wt, the nickel concentration is less than or equal to 150 ppm wt, the sulfur concentration is less than or equal to 500 ppm wt, the arsenic concentration is less than or equal to 1100 ppm wt, and the concentrations of elements other than lithium, cobalt, and oxygen are less than or equal to 150 ppm wt.

Fabrication conditions of the sample 99, the sample 100, the sample 101, the sample 200, and the sample 300 are shown in Table 1.

TABLE 1

| | Particle | Elements | Co:Ni:Al:Mg | Crushing |
|---|---|---|---|---|
| Sample name | diameter | contained | (atomic ratio) | method |
| Sample 99 | small | LiCoO₂ + | 100:0.5:0.5:1 | — |
| (comparative | | Ni + Al + Mg + F | | |
| example) | | | | |
| Sample 100 | | | | thin-film spin |
| | | | | system high- |
| | | | | speed mixer |
| Sample 101 | | | | ball mill |
| Sample 200 | large | | | — |
| Sample 300 | small | LiCoO₂ | — | ball mill |
| (comparative | | | | |
| example) | | | | |

### <Particle Size Distribution>

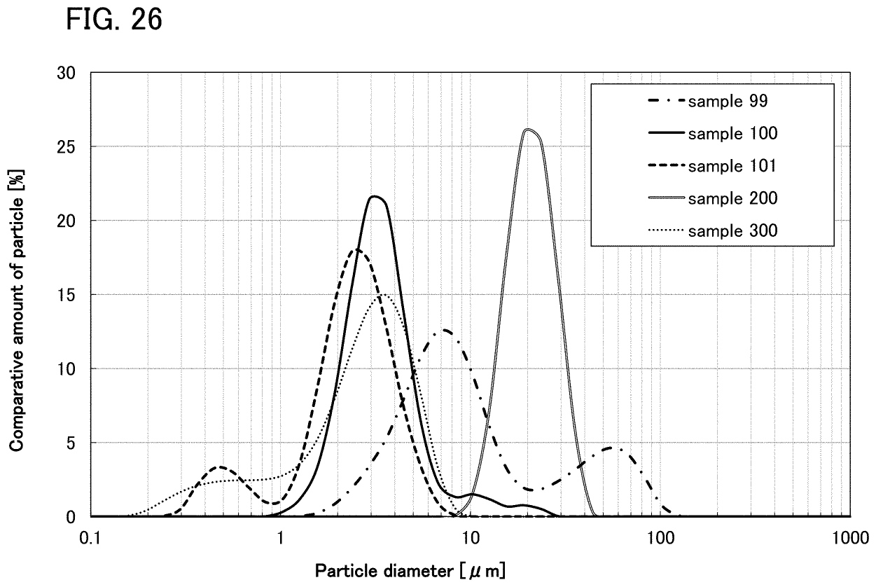

The particle size distributions of the samples shown in Table 1 were measured by a laser diffraction and scattering method. FIG. 26 shows the particle size distributions. Table 2 shows D₅₀, D₁₀, D₉₀, average values, and standard deviations (SD).

TABLE 2

| | D₅₀ | D₁₀ | D₉₀ | Average value ± SD |
|---|---|---|---|---|
| | [μm] | [μm] | [μm] | [μm] |
| Sample 99 | 7.6 | 3.4 | 49.2 | 9.7 ± 4.2 |
| (comparative example) | | | | |
| Sample 100 | 2.9 | 1.8 | 5.2 | 3.1 ± 0.2 |
| Sample 101 | 2.2 | 0.6 | 3.8 | 1.9 ± 0.3 |
| Sample 200 | 18.7 | 12.8 | 27.5 | 18.7 ± 0.1 |
| Sample 300 | 2.5 | 0.6 | 4.7 | 2.1 ± 0.3 |

FIG. 26 shows that the sample 100 and the sample 101 with a relatively small particle diameter and the sample 200 with a relatively large particle diameter were obtained by the method shown in Embodiment 1. In order to crush the sample 99, the method using the thin-film spin system high-speed mixer was found to be preferable to the method using the ball mill because particles were not excessively crushed.

### <PPD>

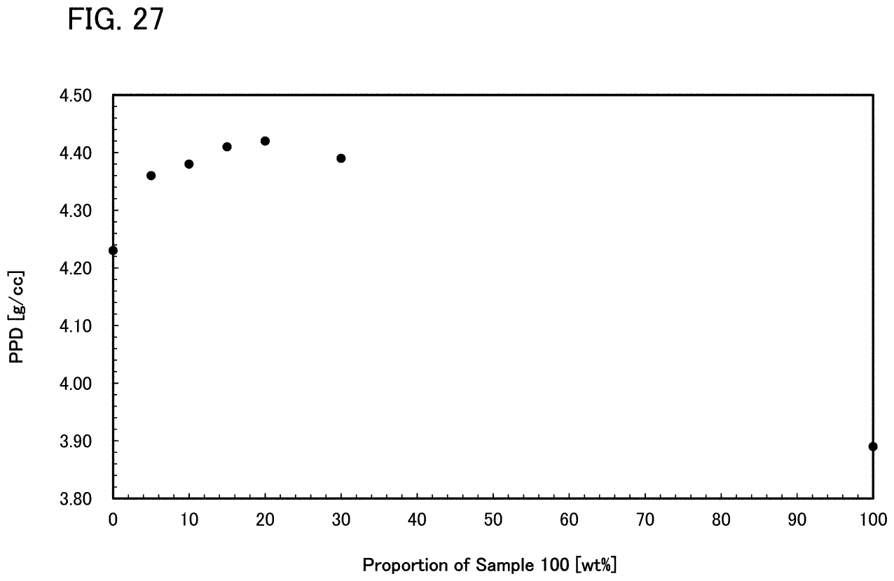

Next, a sample was fabricated by mixing the sample 100 with a small particle diameter and the sample 200 with a large particle diameter and the PPD of the sample was measured. Table 3 shows the mixture ratio of the sample 100 and the sample 200 and the PPD. FIG. 27 is a graph showing the relation between the mixture ratio and the PPD.

TABLE 3

| | Sample 100:Sample 200 | PPD |
|---|---|---|
| | (Weight ratio) | [g/cc] |
| Sample 200 | 0:100 | 4.23 |
| Sample 5:95 | 5:95 | 4.36 |
| Sample 10:90 | 10:90 | 4.38 |
| Sample 15:85 | 15:85 | 4.41 |
| Sample 20:80 | 20:80 | 4.42 |
| Sample 30:70 | 30:70 | 4.39 |
| Sample 100 | 100:0 | 3.89 |

The PPD was higher in the mixture of the sample 100 and the sample 200 than in each sample not mixed. A high PPD of 4.3 g/cc or more was obtained in a sample 5:95 to a sample 30:70, and a sample 20:80 had the best PPD.

### Example 2

In this example, positive electrodes were formed using a positive electrode active material 100′ and a positive electrode active material 100″ that were formed in the same manner as that in Example 1 except for some annealing conditions, cross sections of the positive electrode were observed, and their crystal structures were estimated by XRD. Furthermore, secondary batteries were fabricated and their charge and discharge cycle performance was evaluated.

### <Cross-Sectional SEM>

Positive electrodes for cross-sectional SEM observation were formed in the following manner. Used as positive electrode active materials were a sample 100″, which was formed in the same manner as that in Example 1 except that annealing conditions were changed to 850° C. and 10 hours, and the sample 200, which was formed in the same manner as that in Example 1. Carbon black (TIMCAL SUPER C65, Imerys) was used as a conductive additive and PVDF (Solef 5130, SOLVEY) was used as a binder. A 20-μm-thick aluminum foil was used as a current collector. NMP was used as a solvent.

The mixture ratio of the positive electrode active material, the conductive additive, and the binder was set to the positive electrode active material: the conductive additive: the binder=97:1.5:1.5 (weight ratio). Slurry was formed by the forming method of the positive electrode shown in Embodiment 2 and applied to the current collector, and then subjected to drying and pressure application. The pressure application was performed at 210 kN/m and then 1467 kN/m. The carried amount of the positive electrode active material layer on the current collector was approximately 10 mg/cm².

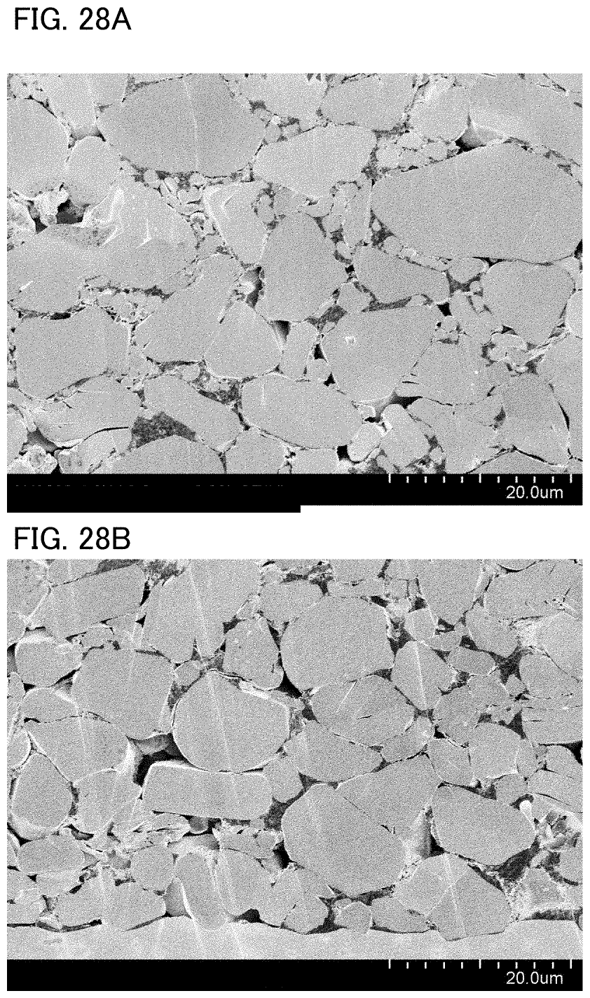

FIG. 28A shows a cross-sectional SEM image of a positive electrode formed using a sample 15:85 (the sample 100″: the sample 200=15:85 (weight ratio)) as the positive electrode active material. FIG. 28B shows a cross-sectional SEM image of a positive electrode formed using only the sample 200 as the positive electrode active material.

In FIG. 28A where the positive electrode active material 100″ with a small particle diameter and the positive electrode active material 200 with a large particle diameter were mixed, there were few spaces without positive electrode active material particles. In contrast, many spaces were observed in FIG. 28B formed only with the positive electrode active material 200 with a large particle diameter.

### <XRD>

Positive electrodes for XRD were formed in the following manner. Used as positive electrode active materials were the sample 100′, which was formed in the same manner as that in Example 1 except that annealing conditions were changed to 800° C. and 10 hours, a sample 100′(2), which was formed in the same manner as the sample 100′ except for the mixture amount of nickel, aluminum, magnesium, and fluorine, and the sample 200, which was formed in the same manner as that in Example 1.

The conductive additive and the binder were the same as those used for cross-sectional SEM observation. The mixture ratio of the positive electrode active material, the conductive additive, and the binder was set to the positive electrode active material: the conductive additive: the binder=95:3:2. After that, slurry was formed in the same manner as that for the cross-sectional SEM observation and applied to the current collector, and then subjected to drying. Note that pressure application was not performed.

By the charging method and the XRD measurement method described in Embodiment 1, coin cells including the positive electrodes formed above were each subjected to one cycle of charge and discharge at 4.6 V and charged again at 4.6 V, and crystal structures were estimated by XRD.

Table 4 shows the fabrication conditions of the sample 100′, the sample 100′(2), and the sample 200, which were formed for XRD measurement, and the charge capacity after one cycle of charge and discharge before XRD measurement.

TABLE 4

| | | | | | Charge capacity |
|---|---|---|---|---|---|
| | | | | | before XDR |
| | Particle | Elements | Co:Ni:Al:Mg | Annealing | measurement |
| Sample name | diameter | contained | (atomic ratio) | conditions | (mAh/g) |
| Sample 100′ | small | LiCoO₂ + | 100:0.5:0.5:1 | 800° C., 10 hr | 213.1 |
| Sample 100′(2) | small | Ni + Al + Mg + F | 100:1:1:2 | 800° C., 10 hr | 210.5 |
| Sample 200 | large | | 100:0.5:0.5:1 | 850° C., 2 hr | 221.3 |

As shown in Table 4, the sample 100′, the sample 100′(2), and the sample 200 each exhibited high charge capacity.

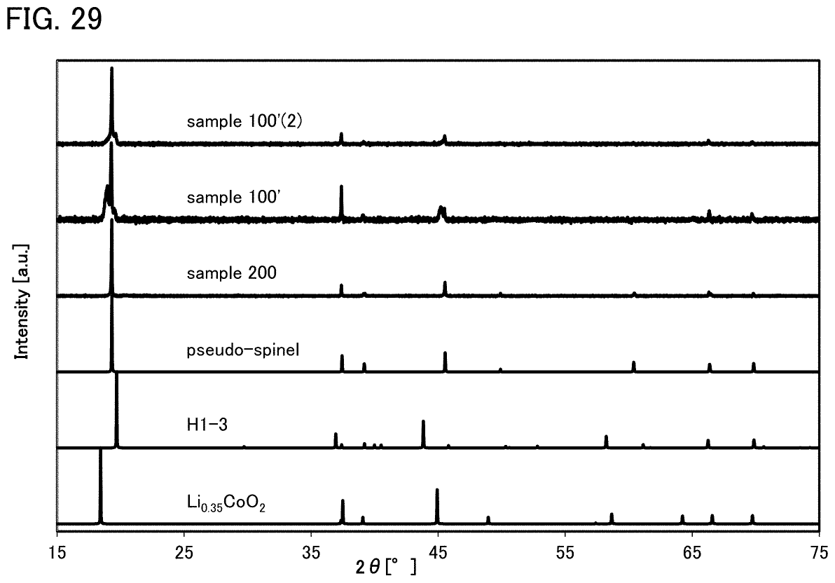

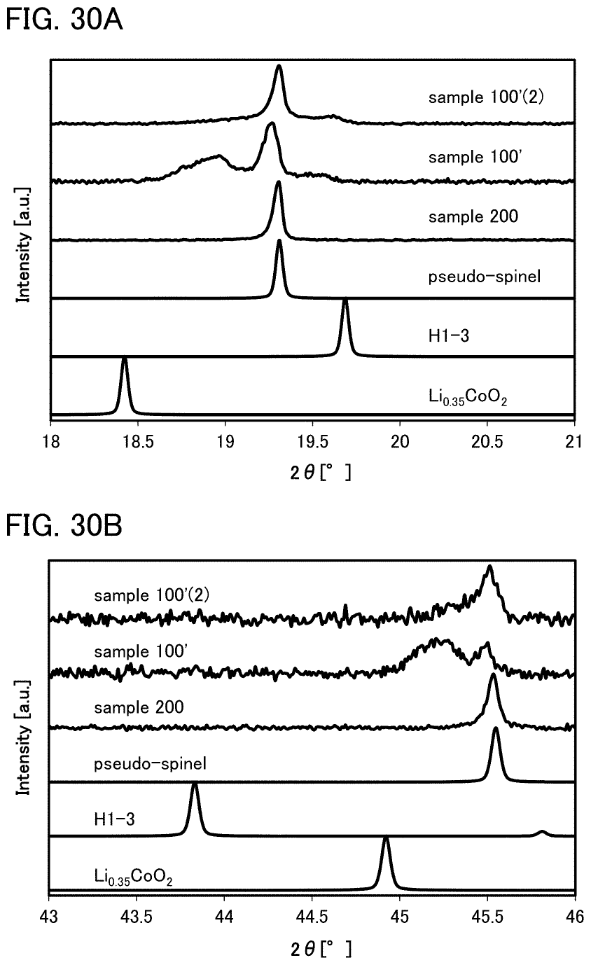

FIG. 29 shows XRD patterns of the positive electrodes using the sample 100′, the sample 100′(2), and the sample 200. For comparison, pseudo-spinel, H1-3, and Li_{0.35}CoO₂ patterns are also shown. FIG. 30A shows enlarged patterns in a region with 2θ of 18 to 21 in FIG. 29 and FIG. 30B shows enlarged patterns in a region with 2θ of 43 to 46 in FIG. 29.

FIG. 29, FIG. 30A, and FIG. 30B show that the sample 100′, the sample 100′(2), and the sample 200 charged at 4.6 V each exhibit diffraction peaks at 2θ=19.30±0.20° and 2θ=45.55±0.10°, i.e., have a pseudo-spinel crystal structure. A feature of an H1-3 type crystal structure was not observed in the samples.

The pattern of the sample 200 has a sharp peak, indicating high crystallinity. Broad peaks appear at approximately 18.9° and 45.2° in the sample 100′, which is probably somewhat influenced by the crystal structure of Li_{0.35}CoO₂.

### <Cycle Performance of Positive Electrode Active Material 100′>

Some kinds of positive electrode active materials 100′ with a small particle diameter were formed by changing the amounts of nickel, aluminum, magnesium, and fluorine and used in secondary batteries; then, the cycle performance thereof was evaluated. Cells for evaluation of the cycle performance were fabricated in the following manner.

The sample 100′, which was formed in the same manner as the sample prepared for the XRD measurement, was used as the positive electrode active material. In addition, a positive electrode active material, which was formed in the same manner as the sample 100′ except that the mixing in Step S41 described in Embodiment was performed so that when the number of cobalt atoms was taken as 100, the number of nickel atoms was 0.75, the number of aluminum atoms was 0.75, and the number of magnesium atoms was 1.5, was used as a sample 100′(1.5). Similarly, a positive electrode active material, which was formed in the same manner as the sample 100′ except that the mixing was performed so that when the number of cobalt atoms was taken as 100, the number of nickel atoms was 1, the number of aluminum atoms was 1, and the number of magnesium atoms was 2, was used as a sample 100′(2). As a comparative example, the positive electrode active material with a small particle diameter that does not contain nickel, aluminum, magnesium, and fluorine, i.e., the sample 300 fabricated in Example 1 was used.

Table 5 shows the fabrication conditions of the sample 100′, the sample 100′(1.5), the sample 100′(2), and the sample 300.

TABLE 5

| | Particle | Elements | Co:Ni:Al:Mg | Crushing |
|---|---|---|---|---|
| Sample name | diameter | contained | (atomic ratio) | method |
| Sample 100′ | small | LiCoO₂ + | 100:0.5:0.5:1 | thin-film spin |
| Sample 100′(1.5) | | Ni + Al + Mg + F | 100:0.75:0.75:1.5 | system high- |
| Sample 100′(2) | | | 100:1:1:2 | speed mixer |
| Sample 300 | | LiCoO₂ | — | ball mill |
| (comparative example) | | | | |

In the fabrication of the samples, a conductive additive, a binder, the mixture ratio of the conductive additive, the binder, and the positive electrode active material, application to a current collector, and pressure application were similar to those of the positive electrode for cross-sectional SEM observation. As an electrolyte solution, with use of 1 mol/L of LiPF₆, a solution in which 2 weight % of VC was mixed in EC and DEC with a volume ratio of EC:DEC=3:7 was used. As a separator, 25-μm-thick polypropylene with a porosity of 41% (Celgard2400, Celgard) was used. A lithium metal was used for a negative electrode. A coin cell (CR2032 type, diameter: 20 mm, height: 3.2 mm) which was formed using stainless steel (SUS) for an exterior body was used.

The secondary batteries fabricated under the above conditions were repeatedly charged and discharged. In charging, constant current charging was performed at 100 mA/g up to 4.6 V and then constant voltage charging was performed until the current value reaches 10 mA/g. In discharging, constant current discharging was performed at 100 mA/g until the voltage reaches 2.5 V. After the discharging, next charging started 10 minutes later. The temperature was 25° C. or 45° C.

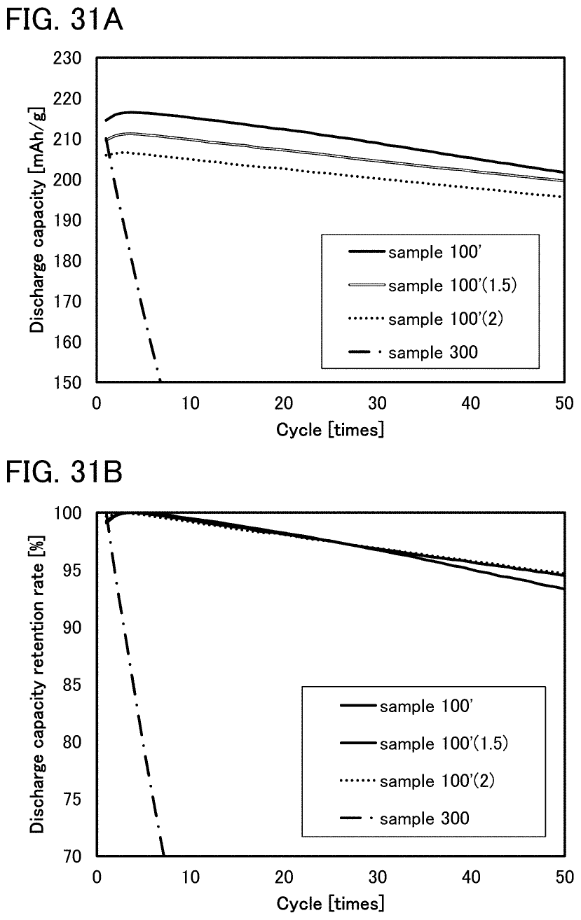

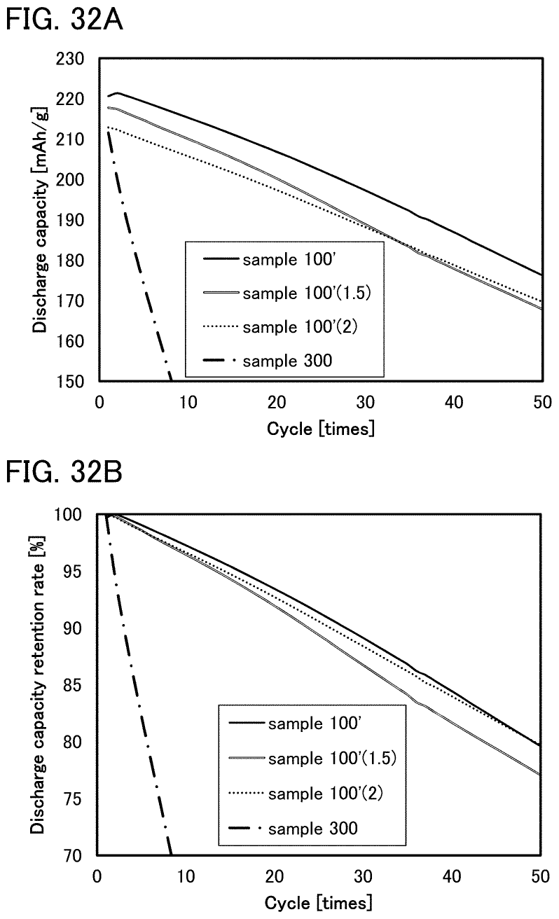

FIG. 31 and FIG. 32 show graphs of the cycle performance measured under the above conditions. FIG. 31A is a graph of the discharge capacity measured at 25° C., and FIG. 31B is a graph of the discharge capacity retention rate measured at 25° C. FIG. 32A is a graph of the discharge capacity measured at 45° C., and FIG. 32B is a graph of the discharge capacity retention rate measured at 45° C.

As is clear from FIG. 31 and FIG. 32, the positive electrode active materials of the sample 100′, the sample 100′(1.5), and the sample 100′(2) all exhibited favorable cycle performance compared with the sample 300, which is the positive electrode active material having a small particle diameter and not containing nickel, aluminum, magnesium, and fluorine.

<Cycle Performance of Group of Particles in which Positive Electrode Active Material 100′ and Positive Electrode Active Material 200 are Mixed>

Next, a group of particles in which the positive electrode active material 100′ with a small particle diameter and the positive electrode active material 200 with a larger particle diameter are mixed was used in secondary batteries; then, the cycle performance thereof was evaluated.

As the positive electrode active material, the sample 200, the sample 5:95, the sample 10:90, the sample 15:85, the sample 20:80, and the sample 100′, which were fabricated in Example 1, were used. The other conditions were the same as those for evaluation of the cycle performance of the positive electrode active material 100′.

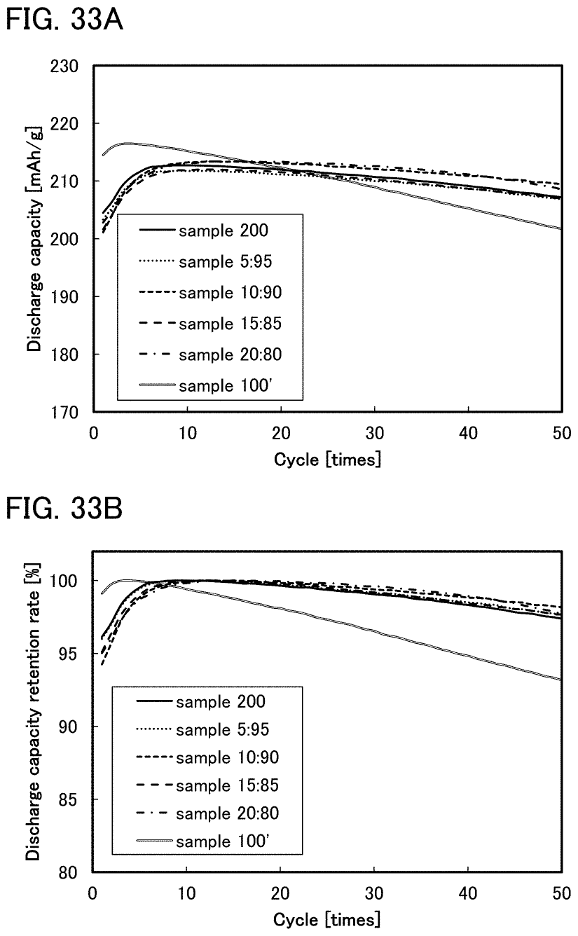

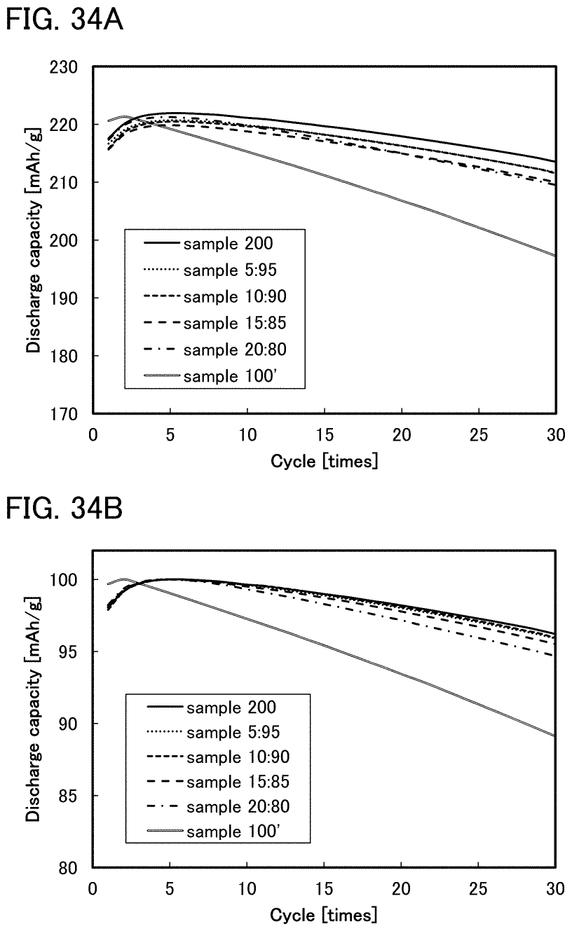

FIG. 33 and FIG. 34 show graphs of the cycle performance measured under the above conditions. FIG. 33A is a graph of the discharge capacity measured at 25° C., and FIG. 33B is a graph of the discharge capacity retention rate measured at 25° C. FIG. 34A is a graph of the discharge capacity measured at 45° C., and FIG. 34B is a graph of the discharge capacity retention rate measured at 45° C.

As is clear from FIG. 33 and FIG. 34, the sample 200, the sample 5:95, the sample 10:90, the sample 15:85, the sample 20:80, and the sample 100′ exhibited favorable cycle performance. The sample 200, the sample 5:95, the sample 10:90, the sample 15:85, and the sample 20:80 exhibited extremely favorable cycle performance. In particular, the sample 10:90 and the sample 20:80 maintained high discharge capacity at 25° C.

Examples described above revealed that a high PPD was obtained by mixing the positive electrode active material with a small particle diameter and the positive electrode active material with a large particle diameter. In addition, the positive electrode active material of one embodiment of the present invention was found to have a pseudo-spinel crystal structure and exhibit favorable cycle performance when being charged with high voltage.

### REFERENCE NUMERALS

100: positive electrode active material, 200: positive electrode active material

1. A positive electrode active material comprising:
a group of particles comprising lithium, cobalt, nickel, aluminum, magnesium, oxygen, and fluorine,
wherein the group of particles comprises a first group of particles and a second group of particles,
wherein when a number of cobalt atoms in the group of particles is taken as 100, a number of nickel atoms is greater than or equal to 0.05 and less than or equal to 2; a number of aluminum atoms is greater than or equal to 0.05 and less than or equal to 2; and a number of magnesium atoms is greater than or equal to 0.1 and less than or equal to 6, and
wherein when particle size distribution in the group of particles is measured by a laser diffraction and scattering method, the first group of particles has a first peak and the second group of particles has a second peak; the first peak has a local maximum value at longer than or equal to 2 μm and shorter than or equal to 4 μm; and the second peak has a local maximum value at longer than or equal to 9 μm and shorter than or equal to 25 μm.

2. The positive electrode active material according to claim 1,
wherein a powder packing density of the positive electrode active material is greater than or equal to 4.30 g/cc and less than or equal to 4.60 g/cc.

3. The positive electrode active material according to claim 1,
wherein when a lithium-ion secondary battery in which the group of particles is used in a positive electrode and metallic lithium is used in a negative electrode is charged at a constant current under a 25° C. environment until a battery voltage reaches 4.6 V and then charged at a constant voltage until a current value reaches 0.02 C and after that the positive electrode is analyzed by powder X-ray diffraction with a CuKα1 ray, diffraction peaks appear at 2θ=19.30±0.20° and 2θ=45.55±0.10°.

4. A positive electrode active material comprising:
a group of particles comprising lithium, cobalt, nickel, aluminum, magnesium, oxygen, and fluorine,
wherein when a number of cobalt atoms in the group of particles is taken as 100, a number of nickel atoms is greater than or equal to 0.05 and less than or equal to 2; a number of aluminum atoms is greater than or equal to 0.05 and less than or equal to 2; and a number of magnesium atoms is greater than or equal to 0.1 and less than or equal to 6,
wherein when particle size distribution is measured by a laser diffraction and scattering method, a local maximum value appears at longer than or equal to 2 μm and shorter than or equal to 4 μm, and
wherein when a lithium-ion secondary battery in which the group of particles is used in a positive electrode and metallic lithium is used in a negative electrode is charged at a constant current under a 25° C. environment until a battery voltage reaches 4.6 V and then charged at a constant voltage until a current value reaches 0.02 C and after that the positive electrode is analyzed by powder X-ray diffraction with a CuKα1 ray, diffraction peaks appear at 2θ=19.30±0.20° and 2θ=45.55±0.10°.

5. A method for manufacturing a positive electrode active material, the method comprising the steps of:
forming a first group of particles comprising lithium, cobalt, nickel, aluminum, magnesium, oxygen, and fluorine, the first group of particles having D₅₀ of longer than or equal to 2 μm and shorter than or equal to 4 μm when particle size distribution is measured by a laser diffraction and scattering method;
forming a second group of particles comprising lithium, cobalt, nickel, aluminum, magnesium, oxygen, and fluorine, the second group of particles having D₅₀ of longer than or equal to 16 μm and shorter than or equal to 22 μm when particle size distribution is measured by a laser diffraction and scattering method; and
forming a group of particles by mixing the first group of particles and the second group of particles,
wherein a proportion of the first group of particles in the group of particles is greater than or equal to 5 weight % and less than or equal to 20 weight %.

6. The method for manufacturing a positive electrode active material according to claim 5,
wherein the step of forming the first group of particles comprises crushing with a thin-film spin system mixer.

7. The method for manufacturing a positive electrode active material according to claim 5,
wherein the step of forming the first group of particles comprises:
forming a first mixture comprising a first composite oxide containing lithium and cobalt, a nickel source, an aluminum source, and a second mixture containing magnesium and fluorine;
heating the first mixture to form a second composite oxide; and
crushing the second composite oxide, and
wherein the heating is performed at higher than or equal to 600° C. and lower than or equal to 950° C. and for longer than or equal to 1 hour and shorter than or equal to 10 hours.

8. The method for manufacturing a positive electrode active material according to claim 7, wherein the heating is performed at 800° C. for 2 hours.

9. The method for manufacturing a positive electrode active material according to claim 7,
wherein when a number of cobalt atoms included in the first composite oxide containing lithium and cobalt is taken as 100, a number of magnesium atoms included in the second mixture is greater than or equal to 0.1 and less than or equal to 6.

10. The method for manufacturing a positive electrode active material according to claim 7,
wherein when a number of cobalt atoms included in the first composite oxide containing lithium and cobalt is taken as 100, a number of magnesium atoms included in the second mixture is greater than or equal to 0.3 and less than or equal to 3.

11. The method for manufacturing a positive electrode active material according to claim 5,
wherein the step of forming the second group of particles comprises:
forming a second mixture comprising a third composite oxide containing lithium and cobalt, a nickel source, an aluminum source, and a third mixture containing magnesium and fluorine; and
heating the second mixture,
wherein the heating is performed at higher than or equal to 600° C. and lower than or equal to 950° C. and for longer than or equal to 3 hours.

12. The method for manufacturing a positive electrode active material according to claim 11,
wherein the heating is performed at higher than or equal to 800° C. and lower than or equal to 850° C. and for longer than or equal to 3 hours and shorter than or equal to 10 hours.

13. The method for manufacturing a positive electrode active material according to claim 11,
wherein when a number of cobalt atoms included in the third composite oxide containing lithium and cobalt is taken as 100, a number of magnesium atoms included in the third mixture is greater than or equal to 0.1 and less than or equal to 6.

14. The method for manufacturing a positive electrode active material according to claim 11,
wherein when a number of cobalt atoms included in the third composite oxide containing lithium and cobalt is taken as 100, a number of magnesium atoms included in the third mixture is greater than or equal to 0.3 and less than or equal to 3.
